(19) United States
(12) Patent Application Publication
(10) Pub. No.: US 2023/0279246 A1
(43) Pub. Date: Sep. 7, 2023

(54) MOLECULE-CONTAINING SURFACES AND METHODS OF PREPARATION THEREOF

(71) Applicant: University of Durham, Durham (GB)

(72) Inventors: Jas Pal Singh Badyal, Durham (GB); Harrison John COX, Shropshire (GB); Jing Li, Xi'an City (CN)

(21) Appl. No.: 18/040,740

(22) PCT Filed: Aug. 4, 2021
(86) PCT No.: PCT/GB2021/052018

§ 371 Date: Feb. 6, 2023

(30) Foreign Application Priority Data
Aug. 7, 2020 (GB) 2012317.0
Nov. 2, 2020 (GB) 2017328.2

(51) Int. Cl. C09D 7/63; C09D 129/08; C09D 123/08; C09D 7/61

(52) U.S. Cl. CPC C09D 7/63; C09D 129/08; C09D 123/0892; C09D 7/61

(57) ABSTRACT

The present invention provides a coating comprising cinnamaldehyde, a cinnamaldehyde derivative, an essential oil, or an essential oil-derived compound; and a polyphenol, polyethyleneimine or poly(4-vinylaniline). The invention also provides a coating comprising cinnamaldehyde, a cinnamaldehyde derivative, an essential oil, or an essential oil-derived compound; a metal, metal-salt or metal-compound; and a polyphenol or a polyphenol-containing substance or solution. Substrates including the coatings applied thereto, and methods of preparing the coatings are also provided.

The invention to which this application relates is molecule-containing surfaces and essential oil composite coatings, and methods of manufacture thereof.

Naturally occurring plant-derived essential oil compounds are known for their antimicrobial benefits. Cinnamaldehyde, a major component of cinnamon bark oil is reported to show antibacterial, antifungal, antiparasitic, insecticidal, antiviral, anticancer, anti-diabetic and pro-wound healing properties. Cinnamaldehyde is antibacterial through multiple mechanisms which vary according to the pathogen. The mode of action of cinnamaldehyde against Escherichia coli and Staphylococcus aureus is reported to involve interaction of cinnamaldehyde with the cell membrane, which results in an increase in the cell permeability, changes to cell morphology, and damaging of cell membrane integrity, ultimately leading to cell lysis and cytoplasmic content leakage. It has also been shown that cinnamaldehyde can cause oxidative damage to E. coli cells. Many of the reported cinnamaldehyde-based antibacterial materials and surfaces involve the blending of cinnamaldehyde with a polymer (either as a melt or in solution) followed by casting into a film. Some of the polymers used include polyvinyl alcohol, polypropylene, polystyrene, cellulose, and chitosan. Such cinnamaldehyde-containing films are effective at stopping bacterial or mould growth on, for example, various foodstuffs, including beef, chicken and ham, vegetables (radish, broccoli, and alfalfa), sprouts, and bakery products. However, manufacture of such essential oil impregnated polymer films requires costly organic solvents or involves application of heat, which can be detrimental due to degradation or volatilization of the bioactive compound. Furthermore, much of the bulk cinnamaldehyde content is inaccessible to the external environment.

Production of polydopamine adhesive coatings via the autoxidation of dopamine in basic solution has been widely reported. These coatings adhere to a variety of substrate materials, including metals, plastics, and even low surface energy polytetrafluoroethylene. The dopamine catechol moieties mimic the adhesive proteins found in mussels, which are capable of adhering to virtually any kind of surface. A related natural coating-forming compound is tannic acid—a plant polyphenol compound, derived from the nutgalls of [symbol] uercus and Sumac (Rhus) species, as well as the seed pods of Tara (Caesalpinia spinosa). Tannic acid also forms an adhesive polymeric coating under oxidising basic conditions, in a similar fashion to polydopamine. One potential issue associated with the use of polydopamine coatings is the relatively high cost of the dopamine hydrochloride, hence tannic acid is recognised as a viable alternative for large scale applications.

Polydopamine alone does not exhibit strong antibacterial activity, and so much research has been conducted into the post-functionalization of polydopamine coatings. Examples include the attachment of silver, copper, quaternary ammonium compounds, zwitterionic compounds, chlorhexidine, antibiotics, peptides, or enzymes. Many of these antibacterial polydopamine-based coatings are unsuitable for industrial scale-up due to their inherent multi-step syntheses, and often prohibitively long reaction times. In addition, there have been reports of combining polydopamine with an antibacterial agent for ‘one-pot’ (single-step) hybrid coatings; for example, polydopamine-silver and polydopamine-copper. In the case of tannic acid coatings, again, methods reported rely upon additives such as silver or copper to impart antibacterial activity.

Antimicrobials such as silver and copper do have inherent drawbacks, chiefly their relatively high cost compared to organic compounds. Also, there exists concern about their environmental impacts, including toxicity to plants and aquatic organisms (as well as a lack of knowledge concerning toxicity in humans). The emergence of antimicrobial resistance is another issue surrounding metal-based antibacterial materials. However, in the present invention, the antimicrobial properties of essential oils and copper/silver are combined together into a coating to provide multiple microbial killing mechanisms, which demonstrate a marked improvement over that which currently exists in the prior art.

Polyethyleneimine polymer comprises repeat units containing two methylene carbons and an amine centre. The ratio of primary to secondary to tertiary amines is typically 1:1:1 in commercially available products. Polyethyleneimine is not particularly antibacterial on its own, but its large number of amine functionalities can be reacted with alkyl halides to yield quaternary ammonium groups which display antibacterial activities.

Further, in the year 2020, the emergence and spread of severe acute respiratory syndrome coronavirus 2 (SARS-CoV-2—which causes the COVID-19 disease) led to the World Health Organization to declare the outbreak a global pandemic. As of June 2021, there have been 3.57 million documented deaths due to the disease. The virus is spread via close contact with infected people (for example, exhaled aerosol droplets) and touching of contaminated surfaces. It has been shown that the virus can remain infectious for several days on a variety of surfaces. Therefore, developing low-cost sustainable technology solutions to help stop the spread of contagious diseases is a critical global challenge for mankind.

Copper and silver are known to display antiviral activities—for example, copper can inactivate influenza virus (H1N1), and silver nanoparticles display an anti-HIV-1 effect. Both metals are reported to be effective against coronaviruses such as SARS-CoV, and Human Coronavirus 229E. Copper surfaces have been found to deactivate SARS-CoV-2—for example, spray-coated copper powder gives rise to 92% reduction after 2 h; and cuprous oxide (Cu₂O) coatings gave about Log₁₀ Reduction=3 towards SARS-CoV-2 viral titre after 1 h. Exposure of SARS-CoV-2 to silver nanoparticles for 1 h prior to infection of cells causes the viral load to drop to negligible levels; and a sputter-coated silver nanocluster/silica composite coating led to Log₁₀ Reduction=4 loss in infectivity after 90 min. However, these previous examples of copper and silver antiviral coatings suffer from drawbacks including lengthy multiple-step fabrication processes, expensive reagents, specialist equipment, and dependency upon substrate material types (which restricts their rapid scale-up and widespread deployment).

In order to help fight against infectious disease transmission on the global scale, the materials and methods employed for producing antimicrobial coatings must be cheap and readily available to facilitate local manufacturing in remote locations and low-income countries, without requiring any specialist training or equipment. The utilisation of ultrathin (nano) coatings and biodegradable substrate materials are important factors for sustainability and environmental impact.

It is an aim of the present invention to provide novel and effective antibacterial coatings which overcome the aforementioned problems associated with the prior art.

It is another aim of the present invention to provide methods or preparing antibacterial coatings which overcome the aforementioned problems associated with the prior art.

It is a further aim of the present invention to provide a low-cost, single-step coating system which overcomes the problems associated with the prior art.

According to a first aspect of the invention, there is provided a coating, said coating comprising:
cinnamaldehyde, a cinnamaldehyde derivative, an essential oil, or an essential oil-derived compound; and
a polyphenol, polyethyleneimine or poly(4-vinylaniline).

Typically, said coating may be an antibacterial coating, an antimicrobial coating, a non-stick coating, anti-adhesive coating, and/or a lubricant.

In one embodiment said coating has an antibacterial or antimicrobial coating.

In one embodiment the coating has hydrophobic characteristics.

Typically, said cinnamaldehyde derivatives include 2-nitrocinnamaldehyde, 3,5-dimethoxy-4-hydroxycinnamaldehyde, 4-(diethylamino)cinnamaldehyde, 4-(dimethylamino)cinnamaldehyde, 4-acetoxy-3-methoxycinnamaldehyde, 4-bromocinnamaldehyde, 4-chlorocinnamaldehyde, 4-fluorocinnamaldehyde, 4-hydroxy-3-methoxycinnamaldehyde, 4-nitrocinnamaldehyde, o-methoxycinnamaldehyde, p-methoxycinnamaldehyde, supercinnamaldehyde, α-amylcinnamaldehyde, α-bromocinnamaldehyde, α-chlorocinnamaldehyde, α-hexylcinnamaldehyde, α-methylcinnamaldehyde, β-phenylcinnamaldehyde, or a derivative of any of these, or a mixture/combination thereof.

Typically, said essential oil may be selected from the group containing Agar oil or oodh, distilled from agarwood (Aquilaria malaccensis); Ajwain oil, from Carum copticum; Angelica root oil, from Angelica archangelica; Anise oil, Asafoetida oil, Balsam of Peru, Basil oil, Bay oil, Bergamot oil, Black pepper oil, Buchu oil, Birch oil, Camphor oil, Cannabis flower essential oil, Calamodin oil, Caraway seed oil, Cardamom seed oil, Carrot seed oil, Cedar oil (or cedarwood oil), Chamomile oil, Calamus oil, Cinnamon oil, Cistus ladanifer oil, Citron oil, Citronella oil, Clary Sage oil, Coconut oil, Clove oil, Coffee oil, Coriander oil, Costmary oil (bible leaf oil), Costus root oil, Cranberry seed oil, Cubeb oil, Cumin seed oil/black seed oil, Cypress oil, Cypriol oil, Curry leaf oil, Davana oil, Dill oil, Elecampane oil, Elemi oil, Eucalyptus oil, Fennel seed oil, Fenugreek oil, Fir oil, Frankincense oil, Galangal oil, Galbanum oil, Garlic oil, Geranium oil, Ginger oil, Goldenrod oil, Grapefruit oil, Henna oil, Helichrysum oil, Hickory nut oil, Horseradish oil, Hyssop oil, Tansy oil, Jasmine oil, Juniper berry oil, Laurus nobilis oil, Lavender oil, Ledum oil, Lemon oil, Lemongrass oil, Lime oil, Litsea cubeba oil, Mandarin oil, Marjoram oil, Melissa oil (Lemon balm), Mentha arvensis oil (mint oil), Moringa oil, Mountain Savory oil, Mugwort oil, Mustard oil, Myrrh oil, Myrtle oil, Neem oil or neem tree oil, Neroli oil, Nutmeg oil, Orange oil, Oregano oil, Orris oil, Palo Santo oil, Parsley oil, Patchouli oil, Perilla oil, Pennyroyal oil, Peppermint oil, Petitgrain oil, Pine oil, Ravensara oil, Red Cedar oil, Roman Chamomile oil, Rose oil, Rosehip oil, Rosemary oil, Rosewood oil, Sage oil, Sandalwood oil, Sassafras oil, Savory oil from Satureja species, Schisandra oil, Spearmint oil, Spikenard oil, Spruce oil, Star anise oil, Tangerine oil, Tarragon oil, Tea tree oil, Thyme oil, Tsuga oil, Turmeric oil, Valerian oil, Warionia oil, Vetiver oil (khus oil). Western red cedar oil, Wintergreen oil, Yarrow oil, Ylang-ylang oil, or a mixture/combination thereof.

Typically, said essential oil-derived compounds may be selected from the group containing 3-carene, allyl isothiocyanate, anethole, berberine, borneol, camphene, carvacrol, carvacrol methyl ester, carvone, caryophyllene oxide, cedrol, cinnamaic acid, cis-hex-3-en-1-ol, citral, citronellal, citronellic acid, curcumin, eucalyptol, eugenol, farnesol, ferulic acid, geraniol, geranyl acetate, limonene, linalool, menthol, menthone, methyl salicylic acid, methyl salycilate, nerol, nerolidol, pinocarvone, polygodial, sabinene, terpinen-4-ol, terpineol, thujone, thymol, tropolone, verbenone, α-pinene, α-terpinene, α-terpineole, β-pinene, β-thujaplicin, or a derivative of any of these, or a mixture/combination thereof.

In one embodiment, said polyphenol may comprise polydopamine or tannic acid.

In another embodiment, said polyphenol may be selected from the group containing Anthocyanidin, Caffeoylquinic acid, Catechin, Catechol, Coumaroylquinic acid, Ellagic acid, Ellagitannin, Epiafzelechin, Epicatechin, Epicatechin gallate, Epigallocatechin, Epigallocatechin gallate, Fisetinidol, Flavanone, Flavanol, Flavone, Gallic Acid, Guibourtinidol, Hydroquinone, Hydroxybenzoic acid, Hydroxycinnamaic acid, Hydroxyhydroquinone, Isoflavone, Mesquitol, Morin, Naringenin, Naringin, Phenol, Phloroglucinol, Procyanidin, Pyrocatechol, Pyrogallol, Quercetin, Resorcinol, Resveratrol, Robinetinidol, Rutin, Theaflavin, Theaflavin-3-gallate, Thearubigin, Tannins, Tannin-containing natural products or species.

Typically, where said coating includes polydopamine, said polydopamine is formed from polymerization of dopamine hydrochloride in a solution of an appropriate agent to induce said polymerization.

In one embodiment, when said coating includes polydopamine, said coating comprises a mixture of cinnamaldehyde, a cinnamaldehyde derivative, an essential oil, or an essential oil-derived compound; dopamine hydrochloride; and a solution of an appropriate agent to induce said polymerization.

Typically, said agent may be chosen from the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. In one embodiment said agent is an aqueous solution of tris(hydroxymethyl)aminomethane (Tris).

Typically, the mass ratio of dopamine hydrochloride:cinnamaldehyde is approximately 1:5. However it should be appreciated that the mass ratio will vary depending upon the materials and/or combination of material which are used to form the coating.

Preferably, when provided, the tris(hydroxymethyl)aminomethane is provided as an aqueous solution at a concentration of 25 mM. Typically, the dopamine hydrochloride is provided at approximately 0.3 wt % solution and the cinnamaldehyde is provided at approximately 1.5% wt % solution.

In one embodiment, where said coating is provided as a combination of cinnamaldehyde and polyethyleneimine, the mass ratio of the two compounds is approximately 1:1. Preferably, cinnamaldehyde and polyethyleneimine are provided at approximately 2 wt % aqueous solution.

In one embodiment, where said coating is provided as a combination of cinnamaldehyde, a cinnamaldehyde derivative, an essential oil, or an essential oil-derived compound and a polyphenol not including polydopamine, the mass ratio of the two compounds is approximately 1:1.

Typically, where said coating is provided as a combination of cinnamaldehyde, and tannic acid, the mass ratio of the two compounds is approximately 1:1. Further typically, cinnamaldehyde and tannic acid are provided in an appropriate buffer solution.

Typically, said buffer solution may be chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. In one embodiment said agent is an aqueous solution of tris(hydroxymethyl)aminomethane (Tris).

Preferably, cinnamaldehyde and tannic acid are provided at approximately 0.3 wt % solution in tris(hydroxymethyl)aminomethane.

In one embodiment, the polyphenol may be provided from a polyphenol-containing solution. Typically, such polyphenol-containing solutions may include fruit juice, wine, cacao, chocolate and/or tea.

In one embodiment, said polyphenol-containing solutions may be mixed with bioactive molecule-containing materials to form bioactive/antibacterial coatings. Typically, said bioactive molecule-containing materials may include essential oil plants, spices, herbs, or combinations thereof. Further typically, said materials may includes turmeric, paprika, black pepper, coriander, fennel, ginger, cardamom, cinnamon, nutmeg, cloves, oregano, garlic, anise and/or the like.

In one embodiment, said coating may be provided as a mixture of poly(4-vinylaniline) and one of cinnamaldehyde, citral, decanal, or 2-methylundecanal.

According to another aspect of the present invention, there is provided a substrate including a coating as defined above applied thereto.

In one embodiment, said coating is provided on a non-porous substrate. Typically, said substrate comprises, polyethylene terephthalate (PET), polypropylene, polyethylene, polystyrene, polyvinyl chloride, nylon, Teflon/polytetrafluoroethylene, polyurethanes, polylactic acid, polyisoprene, polybutadiene, natural rubber, poly(methyl methacrylate), polyimides, any other plastics, copolymers, polysiloxanes; metals such as aluminium, copper, steel; wood, quartz, cotton, wool, ceramics, linoleum, paper/cellulose, cement, textiles, silicon wafer, glass or the like.

In one embodiment, said non-porous substrate may be provided to be functionalised prior to application of the cinnamaldehyde, cinnamaldehyde derivative, essential oil, or essential oil-derived compound thereon.

Typically, said non-porous substrate includes a solid surface, made compatible by surface functionalisation for bioactive agent containment and subsequent controlled release, ranging from zero release to complete release.

Typically, the substrate surface may be functionalised by a range of different techniques, including, but not limited to: thermal chemical vapour deposition; plasma polymerization; chemical vapour deposition (CVD); initiated chemical vapour deposition (iCVD); plasma enhanced chemical vapour deposition (PECVD); liquid spray deposition; excited liquid spray deposition; photodeposition; ion-assisted deposition; electron beam polymerization; gamma-ray polymerization; target sputtering; atomic layer deposition (ALD); graft polymerization; surface coupling reactions; or solution phase polymerization.

In one embodiment, the substrate surface may be functionalised by plasma enhanced chemical vapour deposition (PECVD).

Typically, the substrate surface is functionalised via a coating of a polymer having an appropriate functional group or groups. Typically, such functional groups include amines, aldehydes, anhydrides, carboxylic acids, thiols, hydroxyls, cyanos, halogens, epoxides and/or the like.

In one embodiment, said surface is functionalised via a coating of poly(4-vinylaniline). In other embodiments, the substrate surface may be functionalised via a coating of polymerized forms of any one of the following monomers: allylamine, 2-aminoethyl methacrylate hydrochloride, 2-aminoethylmethacrylamide hydrochloride, N-(3-aminopropyl)methacrylamide hydrochloride, maleic anhydride, vinylbenzaldehyde, allylmercaptan, glycidyl methacrylate, vinylbenzyl chloride, cyanoethyl acrylate, hydroxyethyl methacrylate, acrylic acid, functional siloxanes, functional silanes and the like. Further typically, the functionalised substrate surface may subsequently be immersed in cinnamaldehyde, a cinnamaldehyde derivative, an essential oil, or an essential oil-derived compound to provide the antibacterial coating on said substrate.

In one embodiment, the coated surface may be arranged to be regenerated after a predetermined period of time by re-immersion of the functionalised substrate surface into a solution of cinnamaldehyde, a cinnamaldehyde derivative, an essential oil, or an essential oil-derived compound. In some embodiments, the re-immersion of the functionalised substrate surface may be done so into a solution of a different molecule-containing solution to that which it was initially immersed and coated.

According to another aspect of the invention there is provided a coating, said coating including an amount of cinnamaldehyde or a cinnamaldehyde derivative in combination with any one of: polydopamine, polyethyleneimine, tannic acid or poly(4-vinylaniline).

Typically, said coating is an antibacterial or antimicrobial coating.

In another aspect of the present invention, there is provided a coating on a porous substrate, said substrate being impregnated with an amount of cinnamaldehyde, a cinnamaldehyde derivative, an essential oil, or an essential oil-derived compound.

Typically, said porous substrate comprises non-woven polypropylene, polytetrafluoroethylene membrane (PTFE), polyethylene, polystyrene, polyvinyl chloride, nylon, Teflon/polytetrafluoroethylene, polyurethanes, polylactic acid, polyisoprene, polybutadiene, natural rubber, poly(methyl methacrylate, polyimides, copolymers, polysiloxanes; metals such as aluminium, copper, steel; wood, quartz, cotton, wool, ceramics, linoleum, paper/cellulose, cement, textiles such as knitted cotton, or the like.

In one embodiment, non-woven polypropylene is impregnated with approximately 1.5 wt % aqueous suspension cinnamaldehyde, cinnamaldehyde derivative, essential oil, or essential oil-derived compound.

In one embodiment, PTFE membrane is impregnated with approximately 3 wt % aqueous suspension cinnamaldehyde, cinnamaldehyde derivative, essential oil, or essential oil-derived compound.

In one embodiment, knitted cotton is impregnated with approximately 3 wt % aqueous suspension cinnamaldehyde, cinnamaldehyde derivative, essential oil, or essential oil-derived compound.

According to another aspect of the present invention, there is provided a method of preparing a coating, said method including the steps of:
providing an amount of cinnamaldehyde, a cinnamaldehyde derivative, an essential oil, or an essential oil-derived compound;
mixing said cinnamaldehyde, cinnamaldehyde derivative, essential oil, or essential oil-derived compound with an amount of a polyphenol, polyethyleneimine or poly(4-vinylaniline);
placing a substrate into the combined mixture for a predetermined period of time;
removing the substrate from the mixture;
washing, and subsequently drying the substrate to provide the same with the coating thereon.

Typically, said coating may be an antibacterial coating, an antimicrobial coating, a non-stick coating, anti-adhesive coating, and/or a lubricant.

Preferably said coating is an antibacterial or antimicrobial coating and/or has hydrophobic characteristics.

Typically, said cinnamaldehyde derivatives include 2-nitrocinnamaldehyde, 3,5-dimethoxy-4-hydroxycinnamaldehyde, 4-(diethylamino)cinnamaldehyde, 4-(dimethylamino)cinnamaldehyde, 4-acetoxy-3-methoxycinnamaldehyde, 4-bromocinnamaldehyde, 4-chlorocinnamaldehyde, 4-fluorocinnamaldehyde, 4-hydroxy-3-methoxycinnamaldehyde, 4-nitrocinnamaldehyde, o-methoxycinnamaldehyde, p-methoxycinnamaldehyde, supercinnamaldehyde, α-amylcinnamaldehyde, α-bromocinnamaldehyde, α-chlorocinnamaldehyde, α-hexylcinnamaldehyde, α-methylcinnamaldehyde, β-phenylcinnamaldehyde, or a derivative of any of these, or a mixture/combination thereof.

Typically, said essential oil may be selected from the group containing Agar oil or oodh, distilled from agarwood (Aquilaria malaccensis); Ajwain oil, from Carum copticum; Angelica root oil, from Angelica archangelica; Anise oil, Asafoetida oil, Balsam of Peru, Basil oil, Bay oil, Bergamot oil, Black pepper oil, Buchu oil, Birch oil, Camphor oil, Cannabis flower essential oil, Calamodin oil, Caraway seed oil, Cardamom seed oil, Carrot seed oil, Cedar oil (or cedarwood oil), Chamomile oil, Calamus oil, Cinnamon oil, Cistus ladanifer oil, Citron oil, Citronella oil, Clary Sage oil, Coconut oil, Clove oil, Coffee oil, Coriander oil, Costmary oil (bible leaf oil), Costus root oil, Cranberry seed oil, Cubeb oil, Cumin seed oil/black seed oil, Cypress oil, Cypriol oil, Curry leaf oil, Davana oil, Dill oil, Elecampane oil, Elemi oil, Eucalyptus oil, Fennel seed oil, Fenugreek oil, Fir oil, Frankincense oil, Galangal oil, Galbanum oil, Garlic oil, Geranium oil, Ginger oil, Goldenrod oil, Grapefruit oil, Henna oil, Helichrysum oil, Hickory nut oil, Horseradish oil, Hyssop oil, Tansy oil, Jasmine oil, Juniper berry oil, Laurus nobilis oil, Lavender oil, Ledum oil, Lemon oil, Lemongrass oil, Lime oil, Litsea cubeba oil, Mandarin oil, Marjoram oil, Melissa oil (Lemon balm), Mentha arvensis oil (mint oil), Moringa oil, Mountain Savory oil, Mugwort oil, Mustard oil, Myrrh oil, Myrtle oil, Neem oil or neem tree oil, Neroli oil, Nutmeg oil, Orange oil, Oregano oil, Orris oil, Palo Santo oil, Parsley oil, Patchouli oil, Perilla oil, Pennyroyal oil, Peppermint oil, Petitgrain oil, Pine oil, Ravensara oil, Red Cedar oil, Roman Chamomile oil, Rose oil, Rosehip oil, Rosemary oil, Rosewood oil, Sage oil, Sandalwood oil, Sassafras oil, Savory oil from Satureja species, Schisandra oil, Spearmint oil, Spikenard oil, Spruce oil, Star anise oil, Tangerine oil, Tarragon oil, Tea tree oil, Thyme oil, Tsuga oil, Turmeric oil, Valerian oil, Warionia oil, Vetiver oil (khus oil). Western red cedar oil, Wintergreen oil, Yarrow oil, Ylang-ylang oil, or a mixture/combination thereof.

Typically, said essential oil-derived compounds may be selected from the group containing 3-carene, allyl isothiocyanate, anethole, berberine, borneol, camphene, carvacrol, carvacrol methyl ester, carvone, caryophyllene oxide, cedrol, cinnamaic acid, cis-hex-3-en-1-ol, citral, citronellal, citronellic acid, curcumin, eucalyptol, eugenol, farnesol, ferulic acid, geraniol, geranyl acetate, limonene, linalool, menthol, menthone, methyl salicylic acid, methyl salycilate, nerol, nerolidol, pinocarvone, polygodial, sabinene, terpinen-4-ol, terpineol, thujone, thymol, tropolone, verbenone, α-pinene, α-terpinene, α-terpineole, β-pinene, β-thujaplicin, or a derivative of any of these, or a mixture/combination thereof.

In one embodiment, said polyphenol may comprise polydopamine or tannic acid.

In another embodiment, said polyphenol may be selected from the group containing Anthocyanidin, Caffeoylquinic acid, Catechin, Catechol, Coumaroylquinic acid, Ellagic acid, Ellagitannin, Epiafzelechin, Epicatechin, Epicatechin gallate, Epigallocatechin, Epigallocatechin gallate, Fisetinidol, Flavanone, Flavanol, Flavone, Gallic Acid, Guibourtinidol, Hydroquinone, Hydroxybenzoic acid, Hydroxycinnamaic acid, Hydroxyhydroquinone, Isoflavone, Mesquitol, Morin, Naringenin, Naringin, Phenol, Phloroglucinol, Procyanidin, Pyrocatechol, Pyrogallol, Quercetin, Resorcinol, Resveratrol, Robinetinidol, Rutin, Theaflavin, Theaflavin-3-gallate, Thearubigin, Tannins, Tannin-containing natural products or species.

Typically, where said coating includes polydopamine, said polydopamine is formed from polymerization of dopamine hydrochloride in a solution of an appropriate agent to induce said polymerization.

In one embodiment, when said coating includes polydopamine, said coating is formed by providing a mixture of cinnamaldehyde, a cinnamaldehyde derivative, an essential oil, or an essential oil-derived compound; dopamine hydrochloride; and a solution of an appropriate agent to induce said polymerization.

Typically, said agent may be chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. Preferably said agent is an aqueous solution of tris(hydroxymethyl)aminomethane (Tris).

Typically, the mass ratio of dopamine hydrochloride:cinnamaldehyde is approximately 1:5.

Typically, the mass ratio of dopamine hydrochloride to cinnamaldehyde, cinnamaldehyde derivative, essential oil, or essential oil-derived compound is varied depending upon the particular combination of materials used.

Preferably, the tris(hydroxymethyl)aminomethane is provided as an aqueous solution at a concentration of 25 mM. Typically, the dopamine hydrochloride is provided at approximately 0.3 wt % solution and the cinnamaldehyde is provided at approximately 1.5% wt % solution.

In one embodiment, where said coating is provided as a combination of cinnamaldehyde and polyethyleneimine, the mass ratio of the two compounds is provided to be approximately 1:1. Preferably, cinnamaldehyde and polyethyleneimine are provided at approximately 2 wt % aqueous solution.

In one embodiment, where said coating is provided as a combination of cinnamaldehyde, a cinnamaldehyde derivative, an essential oil, or an essential oil-derived compound and a polyphenol not including polydopamine, the mass ratio of the two compounds is provided to be approximately 1:1.

Typically, where said coating is provided as a combination of cinnamaldehyde, and tannic acid, the mass ratio of the two compounds is provided to be approximately 1:1. Further typically, cinnamaldehyde and tannic acid are provided in an appropriate buffer solution.

Typically, said buffer solution may be chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. Preferably said agent is an aqueous solution of tris(hydroxymethyl)aminomethane (Tris).

Preferably, cinnamaldehyde and tannic acid are provided at approximately 0.3 wt % solution in tris(hydroxymethyl)aminomethane.

Typically, said substrate is provided as a non-porous substrate. Further typically, said substrate comprises, polyethylene terephthalate (PET), polypropylene, polyethylene, polystyrene, polyvinyl chloride, nylon, Teflon/polytetrafluoroethylene, polyurethanes, polylactic acid, polyisoprene, polybutadiene, natural rubber, poly(methyl methacrylate), polyimides, any other plastics, copolymers, polysiloxanes; metals such as aluminium, copper, steel; wood, quartz, cotton, wool, ceramics, linoleum, paper/cellulose, cement, textiles, silicon wafer, glass or the like.

In one embodiment, said substrate is placed into the combined mixture for a period of at least 24 hours. Typically, said substrate and mixture are shaken for the duration of said period of time. Preferably, said substrate and mixture are maintained at a temperature of 20° C. for the duration of said period of time.

In one embodiment, upon removal of said substrate from the combined mixture, the substrate is washed in pure, distilled and/or deionized water. Typically, said substrate is washed for at least 5 minutes. Typically, said substrate is shaken whilst being washed.

In one embodiment, the substrate is subsequently dried for at least 3 hours. Typically, said substrate is dried at a temperature of 20° C.

In another aspect of the present invention, there is provided a method of preparing a coating, said method including the steps of:
providing a solution of cinnamaldehyde, a cinnamaldehyde derivative, an essential oil, or an essential oil-derived compound;
providing a substrate on to which the coating is to be applied;
functionalising the surface of the substrate via the deposition of a polymer thereon;
immersing the polymer-coated substrate into the solution of cinnamaldehyde, cinnamaldehyde derivative, essential oil, or essential oil-derived compound for a predetermined period of time;
removing the substrate from the solution;
washing, and subsequently drying the substrate to provide the same with the coating thereon.

Typically, said coating may be an antibacterial coating, an antimicrobial coating, a non-stick coating, anti-adhesive coating, and/or a lubricant.

In one embodiment said coating is an antibacterial or antimicrobial coating and/or has hydrophobic characteristics.

Typically, said substrate is a non-porous substrate including a solid surface, made compatible by surface functionalisation for bioactive agent containment and subsequent release.

Typically, the substrate surface may be functionalised by a range of different techniques, including, but not limited to: thermal chemical vapour deposition; plasma polymerization; chemical vapour deposition (CVD); initiated chemical vapour deposition (iCVD); plasma enhanced chemical vapour deposition (PECVD); liquid spray deposition; excited liquid spray deposition; photodeposition; ion-assisted deposition; electron beam polymerization; gamma-ray polymerization; target sputtering; atomic layer deposition (ALD); graft polymerization; surface coupling reactions; or solution phase polymerization.

In one embodiment, the substrate surface may be functionalised by plasma enhanced chemical vapour deposition (PECVD).

Typically, polymer deposited on the substrate surface to functionalise the same may be a polymer having an appropriate functional group or groups. Typically, such functional groups include amines, aldehydes, anhydrides, carboxylic acids, thoils, hydroxyls, cyanos, halogens, epoxides and/or the like.

In one embodiment, said surface is functionalised via a coating of poly(4-vinylaniline). In other embodiments, the substrate surface may be functionalised via a coating of polymerized forms of any one of the following monomers: allylamine, 2-aminoethyl methacrylate hydrochloride, 2-aminoethylmethacrylamide hydrochloride, N-(3-aminopropyl)methacrylamide hydrochloride, maleic anhydride, vinylbenzaldehyde, allylmercaptan, glycidyl methacrylate, vinylbenzyl chloride, cyanoethyl acrylate, hydroxyethyl methacrylate, acrylic acid, functional siloxanes, functional silanes and the like.

In one embodiment, the substrate may be coated with poly(4-vinylaniline) and subsequently immersed in one of cinnamaldehyde, citral, decanal, or 2-methylundecanal.

In one embodiment, the coated surface may be subsequently regenerated after a predetermined period of time by re-immersion of the functionalised substrate surface into a solution of cinnamaldehyde, a cinnamaldehyde derivative, an essential oil, or an essential oil-derived compound. In some embodiments, the re-immersion of the functionalised substrate surface may be done so into a solution of a different molecule-containing solution to that which it was initially immersed and coated.

According to another aspect of the present invention, there is provided a method of preparing a coating, said method including the steps of:
providing an amount of cinnamaldehyde or a cinnamaldehyde derivative;
mixing said cinnamaldehyde or cinnamaldehyde derivative with an amount of any one of: polydopamine, polyethyleneimine, tannic acid or poly(4-vinylaniline);
placing a substrate into the combined mixture for a predetermined period of time;
removing the substrate from the mixture;
washing, and subsequently drying the substrate to provide the same with the coating thereon.

Typically, said coating is an antibacterial or antimicrobial coating and/or has hydrophobic characteristics.

Typically, said substrate is a non-porous substrate.

In another aspect of the present invention, there is provided a method of preparing a coating on a porous substrate, said method including the steps of:
providing an aqueous suspension of cinnamaldehyde, a cinnamaldehyde derivative, an essential oil, or an essential oil-derived compound;
immersing said porous substrate into said suspension for a predetermined period of time;
removing the substrate from the suspension;
washing, and subsequently drying the substrate to provide the same with the coating impregnated therein.

Typically, said porous substrate comprises non-woven polypropylene, polytetrafluoroethylene membrane (PTFE), knitted cotton or the like.

Typically, said cinnamaldehyde, cinnamaldehyde derivative, essential oil, or essential oil-derived compound suspension is provided as at least 1.5 wt % aqueous suspension.

In one embodiment, non-woven polypropylene is immersed in a 1.5 wt % aqueous suspension cinnamaldehyde, cinnamaldehyde derivative, essential oil, or essential oil-derived compound.

In one embodiment, PTFE membrane is immersed in a 3 wt % aqueous suspension cinnamaldehyde, cinnamaldehyde derivative, essential oil, or essential oil-derived compound.

In one embodiment, knitted cotton is immersed in a 3 wt % aqueous suspension cinnamaldehyde, cinnamaldehyde derivative, essential oil, or essential oil-derived compound.

In one embodiment, said substrate is placed into the cinnamaldehyde, cinnamaldehyde derivative, essential oil, or essential oil-derived compound suspension for a period of at least 24 hours. Typically, said substrate and suspension are shaken for the duration of said period of time. Preferably, said substrate and suspension are maintained at a temperature of 20° C. for the duration of said period of time.

In one embodiment, upon removal of said substrate from the suspension, the substrate is washed in pure, distilled and/or deionized water. Typically, said substrate is washed for at least 5 minutes. Typically, said substrate is shaken whilst being washed.

In one embodiment, the substrate is subsequently dried for at least 3 hours. Typically, said substrate is dried at a temperature of 20° C.

The present invention therefore provides a single-step dip-coating deposition of molecule-containing antibacterial surface layers. Such molecules may be chosen from any of cinnamaldehyde, cinnamaldehyde derivatives, essential oils, or essential oil-derived compounds. Dopamine is polymerized in the presence of an aqueous solution containing tris(hydroxymethyl)aminomethane and cinnamaldehyde. Analogous antibacterial coatings are prepared by combining polyethyleneimine or tannic acid with cinnamaldehyde. Additionally, cinnamaldehyde is impregnated into a range of porous materials, including non-woven polypropylene cloth, polytetrafluoroethylene membrane, and knitted cotton, via simple dip-coating, to achieve high levels of antibacterial activity over extended recycling.

Typically the coatings include particles and/or nanoparticles in the coatings in order to provide enhanced durability, lubricity, and/or scratch-resistance and the selection of the particles and/or nano-particles can be made with regard to the subsequent use of the coating and/or base to which the same is fitted.

Typically the method includes a step of adding selected particles and/or nano-particles so that they becoming part of the coating which is applied.

Typically, the particles and/or nano particles can be unfunctionalised or functionalised particles or nanoparticles and may include any or any combination of silica, nanotubes, colloidal metals, alloys of metals, metal oxides, metal non-oxides, quantum dots, ceramics, silicates, aluminosilicates, polymeric materials, and unfunctionalised or functionalised layer materials (such as graphenes, clays, micas, transition-metal dichalcogenides).

In one embodiment Precursors (X-Y) for polymerisation are prepared by reacting molecules (X) with polymerisable monomers (Y) to create molecule-monomer precursors (X-Y) and these can, in one embodiment, be employed to create coatings into which molecules (X) can be further incorporated to create the desired coatings. Polymerisation can be undertaken using solution, slurry, solid, or spray methods including, but not limited to: thermal chemical vapour deposition; plasma polymerization; chemical vapour deposition (CVD); initiated chemical vapour deposition (iCVD); plasma enhanced chemical vapour deposition (PECVD); liquid spray deposition; excited liquid spray deposition; photodeposition; ion-assisted deposition; electron beam polymerization; gamma-ray polymerization; target sputtering; atomic layer deposition (ALD); graft polymerization; surface coupling reactions; or solution phase polymerization.

According to another aspect of the invention, there is provided a coating, said coating comprising:
cinnamaldehyde, a cinnamaldehyde derivative, an essential oil, or an essential oil-derived compound;
a metal, metal-salt or metal-compound; and
a polyphenol or a polyphenol-containing substance or solution.

Typically, said coating may be an antibacterial coating, an antimicrobial coating, a non-stick coating, anti-adhesive coating, and/or a lubricant.

In one embodiment said coating is an antibacterial or antimicrobial coating.

Typically, said metal, metal-salt or metal-compound includes silver or copper, or silver- or copper-salts or compounds thereof. Further typically, said metal salts may comprise silver nitrate or copper sulphate pentahydrate.

In other embodiments, said metal salts may include any of the following: silver carbonate, silver chlorate, silver chloride, silver chromate, silver citrate, silver cyanate, silver cyanide, silver(I) fluoride, silver(II) fluoride, silver heptafluorobutyrate, silver hexafluoroantimonate(V), silver hexafluorophosphate, silver iodide, silver lactate, silver nitrite, silver pentafluoropropionate, silver perchlorate, silver(I) perrhenate, silver phosphate, silver(I) sulfadiazine, silver sulfate, silver tetrafluoroborate, silver thiocyanate, silver p-toluenesulfonate, copper silicide, copper(I) oxide, copper(I) chloride, copper(I) iodide, copper(I) cyanide, copper(I) thiocyanate, copper (I) sulfate, copper(I) sulfide, copper(I) acetylide, copper(I) bromide, copper(I) fluoride, copper(I) hydroxide, copper(I) hydride, copper(I) nitrate, copper(I) phosphide, copper(I) thiophene-2-carboxylate, copper(I) t-butoxide, copper(II) sulfate anhydrous, copper(II) chloride, copper(II) hydroxide, copper(II) nitrate, copper(II) oxide, copper(II) acetate, copper(II) fluoride, copper(II) bromide, copper(II) carbonate, copper(II) carbonate hydroxide, copper(II) chlorate, copper(II) arsenate, copper(II) azide, copper(II) acetylacetonate, copper(II) aspirinate, copper(II) cyanurate, copper(II) glycinate, copper(II) phosphate, copper(II) perchlorate, copper(II) selenite, copper(II) sulfide, copper(II) thiocyanate, copper(II) triflate, copper(II) tetrafluoroborate, copper(II) acetate triarsenite, copper(II) benzoate, copper(II) arsenite, copper(II) chromite, copper(II) gluconate, copper(II) peroxide, copper(II) usnate, copper(III) oxide.

In other embodiments, other metals which may be derived from metal salt or metal compound for use in the invention include: gold, nickel, cobalt, palladium, platinum, chromium, rhodium, ruthenium, iron, zinc, titanium, zirconium, molybdenum, tin, lead, etc. Typically, metal alloy combinations derived from combinations of metal salts or metal compounds may also be used.

In one embodiment, said polyphenol is provided as an amount of tannic acid.

In a preferred embodiment, said polyphenol or polyphenol-containing substance or solution is brewed tea. Preferably, said brewed tea is brewed green tea.

In another embodiment, said polyphenol-containing substance or solution may include any of the following: fruit juice, wine, cacao, chocolate, coffee, herbal tea, and spiced beverages.

In one embodiment, said coating components may optionally be provided in an appropriate buffer solution. Typically, said buffer solution may be chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. In one embodiment said agent is an aqueous solution of tris(hydroxymethyl)aminomethane (Tris).

In one embodiment, said coating may optionally include an amount of an aqueous solution of tris(hydroxymethyl)aminomethane (Tris). Preferably, the tris(hydroxymethyl)aminomethane is provided as an aqueous solution at a concentration of 25 mM.

In one embodiment, said coating is provided for deposition on a substrate.

According to another aspect of the present invention, there is provided a substrate including a coating as defined above applied thereto.

In one embodiment, said coating is provided on a non-porous substrate. Typically, said substrate comprises, polyethylene terephthalate (PET), polypropylene, polyethylene, polystyrene, polyvinyl chloride, nylon, Teflon/polytetrafluoroethylene, polyurethanes, polylactic acid, polyisoprene, polybutadiene, natural rubber, poly(methyl methacrylate), polyimides, any other plastics, copolymers, polysiloxanes; metals such as aluminium, copper, steel; wood, quartz, cotton, wool, ceramics, linoleum, paper/cellulose, cement, textiles, silicon wafer, glass or the like.

In another embodiment, said coating is provided on a porous substrate. Typically, said porous substrate comprises non-woven polypropylene, polytetrafluoroethylene membrane (PTFE), polyethylene, polystyrene, polyvinyl chloride, nylon, Teflon/polytetrafluoroethylene, polyurethanes, polylactic acid, polyisoprene, polybutadiene, natural rubber, poly(methyl methacrylate, polyimides, copolymers, polysiloxanes; metals such as aluminium, copper, steel; wood, quartz, cotton, wool, ceramics, linoleum, paper/cellulose, cement, textiles such as knitted cotton, or the like.

In one embodiment, said substrate may be provided as a face mask, glove or other item of personal protective equipment (PPE). Thus, the coating of the present invention may be applied to various items of PPE to provide an additional layer of safety/security against viral, bacterial and/or microbial infection. In particular, application of the coating in accordance with the invention to PPE items and materials allows the same to be recyclable and reusable in relation to many sorts of bacteria or virus, including Coronavirus disease (COVID-19).

According to another aspect of the present invention, there is provided a method of preparing a coating, said method including the steps of:
providing an amount of cinnamaldehyde, cinnamaldehyde derivative, an essential oil, or an essential oil-derived compound;
providing an amount of a metal salt or metal-compound;
providing an amount of a polyphenol or a polyphenol-containing substance;
mixing the aforementioned substances together;
placing a substrate into the combined mixture for a predetermined period of time;
removing the substrate from the mixture;
washing, and subsequently drying the substrate to provide the same with the coating thereon.

Typically, said coating is an antibacterial or antimicrobial coating and/or has hydrophobic characteristics.

In one embodiment, said substrate is placed into the combined mixture for a period of at least 24 hours. Typically, said substrate and mixture are shaken for the duration of said period of time. Preferably, said substrate and mixture are maintained at a temperature of 20° C. for the duration of said period of time.

In one embodiment, upon removal of said substrate from the combined mixture, the substrate is washed in pure, distilled and/or deionized water. Typically, said substrate is washed for at least 5 minutes. Typically, said substrate is shaken whilst being washed.

In one embodiment, the substrate is subsequently dried for at least 3 hours. Typically, said substrate is dried at a temperature of 20° C. In another embodiment, the substrate may be dried under vacuum, in a vacuum oven, or at an elevated temperature.

Typically, said metal may include silver or copper. Further typically, said metal salts may comprise silver nitrate or copper sulphate pentahydrate.

In other embodiments, other metals which may be derived from metal salt or metal compound for use in the invention include: gold, nickel, cobalt, palladium, platinum, chromium, rhodium, ruthenium, iron, zinc, titanium, zirconium, molybdenum, tin, lead, etc. Typically, metal alloy combinations derived from combinations of metal salts or metal compounds may also be used.

In other embodiments, said metal salts may include any of the following: silver carbonate, silver chlorate, silver chloride, silver chromate, silver citrate, silver cyanate, silver cyanide, silver(I) fluoride, silver(II) fluoride, silver heptafluorobutyrate, silver hexafluoroantimonate(V), silver hexafluorophosphate, silver iodide, silver lactate, silver nitrite, silver pentafluoropropionate, silver perchlorate, silver(I) perrhenate, silver phosphate, silver(I) sulfadiazine, silver sulfate, silver tetrafluoroborate, silver thiocyanate, silver p-toluenesulfonate, copper silicide, copper(I) oxide, copper(I) chloride, copper(I) iodide, copper(I) cyanide, copper(I) thiocyanate, copper (I) sulfate, copper(I) sulfide, copper(I) acetylide, copper(I) bromide, copper(I) fluoride, copper(I) hydroxide, copper(I) hydride, copper(I) nitrate, copper(I) phosphide, copper(I) thiophene-2-carboxylate, copper(I) t-butoxide, copper(II) sulfate anhydrous, copper(II) chloride, copper(II) hydroxide, copper(II) nitrate, copper(II) oxide, copper(II) acetate, copper(II) fluoride, copper(II) bromide, copper(II) carbonate, copper(II) carbonate hydroxide, copper(II) chlorate, copper(II) arsenate, copper(II) azide, copper(II) acetylacetonate, copper(II) aspirinate, copper(II) cyanurate, copper(II) glycinate, copper(II) phosphate, copper(II) perchlorate, copper(II) selenite, copper(II) sulfide, copper(II) thiocyanate, copper(II) triflate, copper(II) tetrafluoroborate, copper(II) acetate triarsenite, copper(II) benzoate, copper(II) arsenite, copper(II) chromite, copper(II) gluconate, copper(II) peroxide, copper(II) usnate, copper(III) oxide.

In one embodiment, said polyphenol is provided as an amount of tannic acid.

In another embodiment, said polyphenol-containing substance or solution may include any of the following: fruit juice, wine, cacao, chocolate, coffee, herbal tea, and spiced beverages. In one embodiment, said polyphenol-containing substance or solution is provided as an amount of green tea.

In one embodiment, said coating components may optionally be provided in an appropriate buffer solution. Typically, said buffer solution may be chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof. In one embodiment said agent is an aqueous solution of tris(hydroxymethyl)aminomethane (Tris).

In one embodiment, the method further includes adding an amount of an aqueous solution of tris(hydroxymethyl)aminomethane (Tris) and mixing the same to form the combined mixture, prior to addition of the substrate. Preferably, the tris(hydroxymethyl)aminomethane is provided as an aqueous solution at a concentration of 25 mM.

Embodiments of the present invention will now be described with reference to the accompanying figures, wherein:

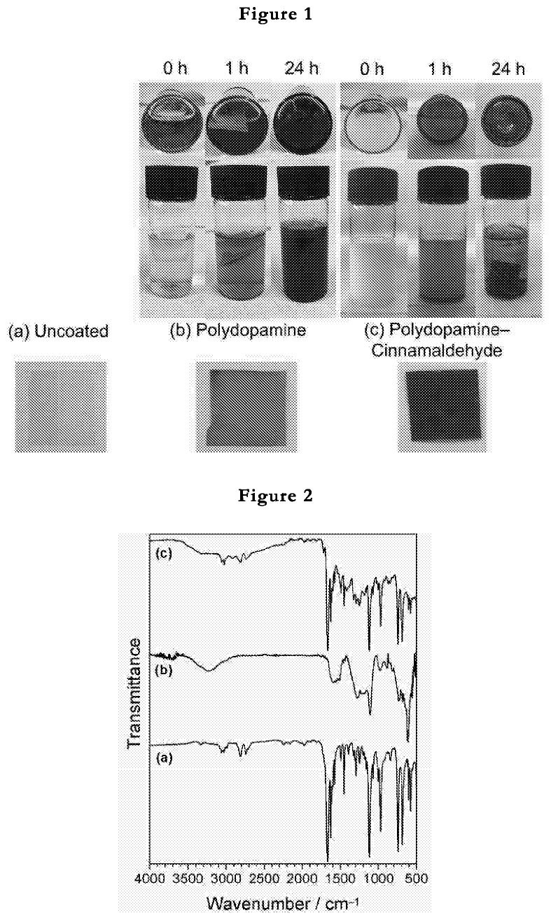

FIGS. 1a-c illustrate photographs of coating solutions and 15×15 mm PET film: (a) uncoated; (b) polydopamine-only; and (c) polydopamine-cinnamaldehyde, according to an embodiment of the present invention;

FIG. 2 illustrates Infrared spectra of: (a) cinnamaldehyde; (b) polydopamine-only coating; and (c) polydopamine-cinnamaldehyde coating;

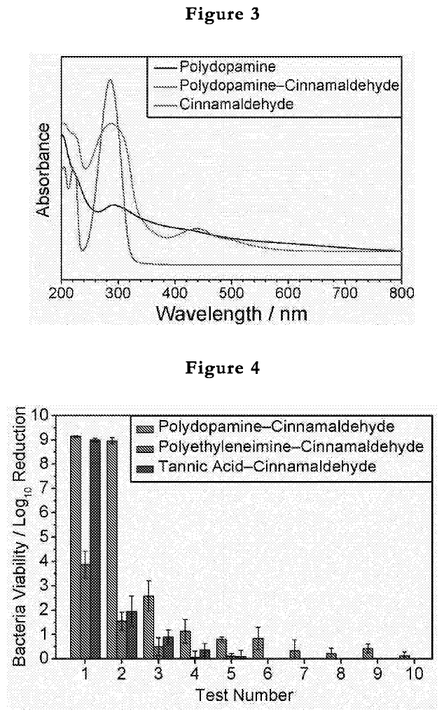

FIG. 3 illustrates UV-Vis spectra of cinnamaldehyde solution; polydopamine coated quartz; and polydopamine-cinnamaldehyde coated quartz;

FIG. 4 illustrates recycle antibacterial activity against E. coli for coated PET films: polydopamine-cinnamaldehyde; polyethyleneimine-cinnamaldehyde; and tannic acid-cinnamaldehyde;

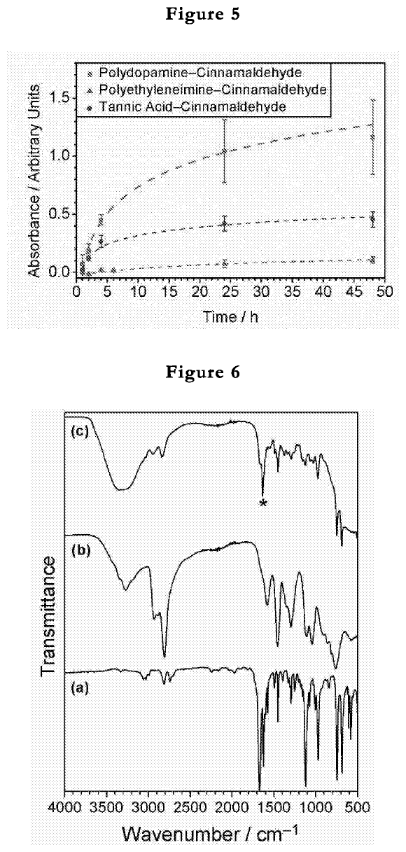

FIG. 5 illustrates release of cinnamaldehyde from antibacterial coatings into water at 20° C. monitored by UV-Vis spectroscopy 290 nm): polydopamine-cinnamaldehyde; polyethyleneimine-cinnamaldehyde; and tannic acid-cinnamaldehyde;

FIG. 6 illustrates infrared spectra of: (a) cinnamaldehyde; (b) polyethyleneimine; and (c) polyethyleneimine-cinnamaldehyde coating;

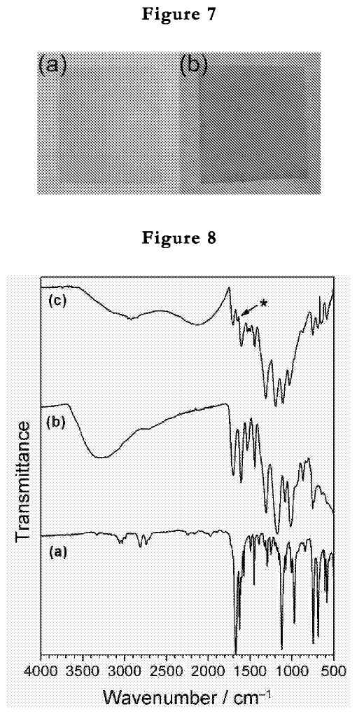

FIGS. 7a-b illustrate photographs of PET film: (a) uncoated; and (b) tannic acid-cinnamaldehyde coating, in accordance with an embodiment of the present invention;

FIG. 8 illustrates infrared spectra of: (a) cinnamaldehyde; (b) tannic acid; and (c) tannic acid-cinnamaldehyde coating;

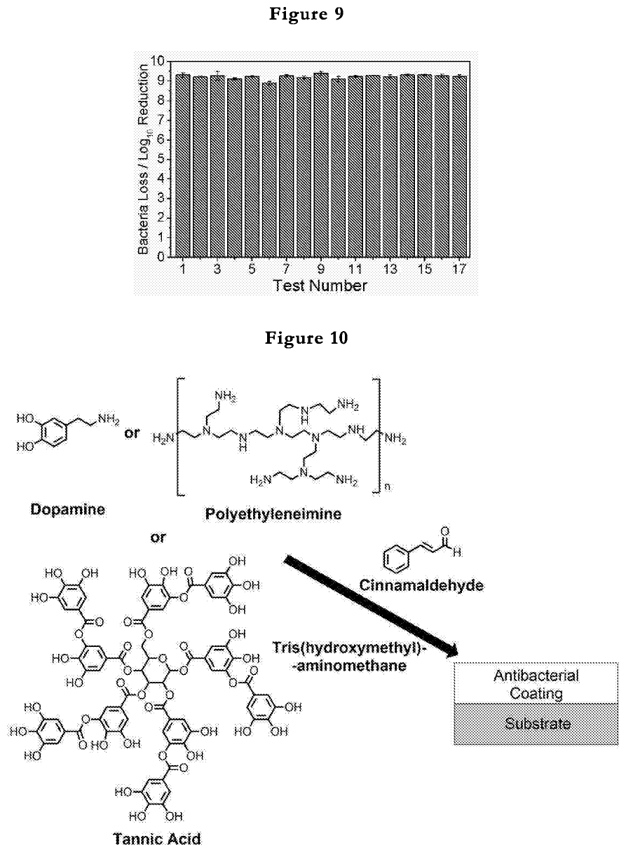

FIG. 9 illustrates E. coli antibacterial recycling of cinnamaldehyde impregnated non-woven polypropylene cloth;

FIG. 10 illustrates a schematic of the deposition of polydopamine-cinnamaldehyde, polyethyleneimine-cinnamaldehyde, and tannic acid-cinnamaldehyde antibacterial coatings, in accordance with embodiments of the present invention;

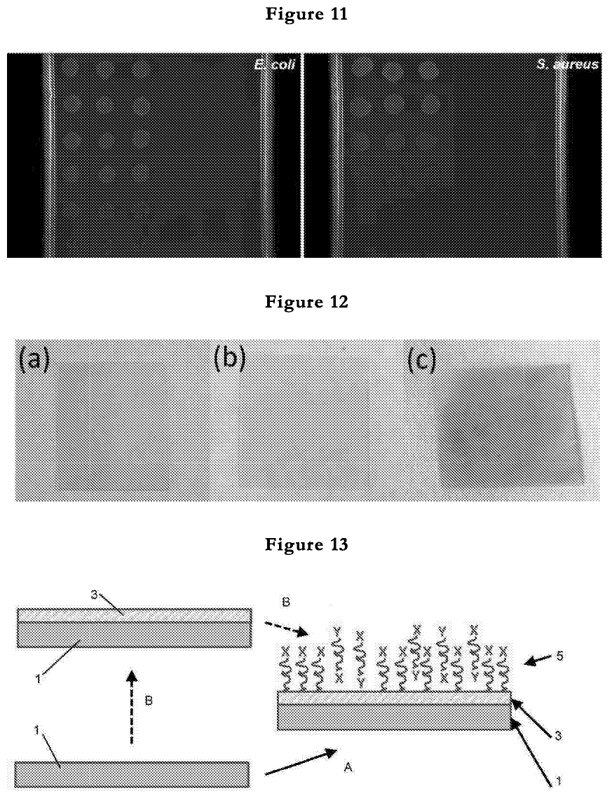

FIG. 11 illustrates photographs of antibacterial test agar plates for E. coli and S. aureus;

FIGS. 12a-c illustrate photographs of transparent PET polymer substrate: (a) no coating; (b) green tea coating; and (c) green tea-cinnamaldehyde coating;

FIG. 13 illustrates a schematic of single-step and a multi-step process options for providing a coating on a surface, in accordance with embodiments of the present invention;

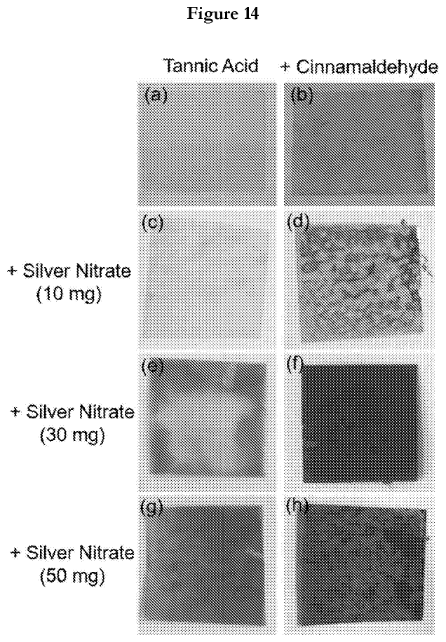

FIG. 14 illustrates photographs of a PET film substrate: (a) uncoated; (b) tannic acid-cinnamaldehyde; (c) tannic acid-silver nitrate (10 mg); (d) tannic acid-cinnamaldehyde-silver nitrate (10 mg); (e) tannic acid-silver nitrate (30 mg); (f) tannic acid-cinnamaldehyde-silver nitrate (30 mg); (g) tannic acid-silver nitrate (50 mg); and (h) tannic acid-cinnamaldehyde-silver nitrate (50 mg) (tannic acid and cinnamaldehyde content in coating solutions was kept constant at 30 mg for each);

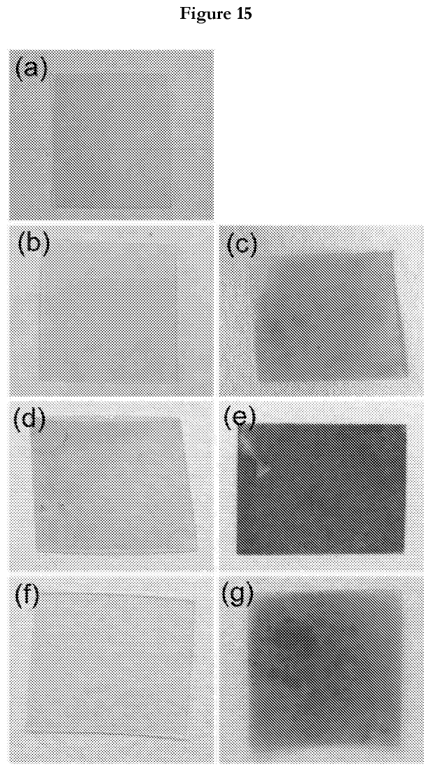

FIG. 15 illustrates photographs of a PET substrate: (a) no coating; (b) tea coating; (c) tea-cinnamaldehyde (30 mg) coating. (d) tea-silver nitrate (10 mg); (e) tea-cinnamaldehyde-silver nitrate (10 mg); (f) tea-copper sulphate pentahydrate (10 mg); and (g) tea-cinnamaldehyde-copper sulphate pentahydrate (10 mg);

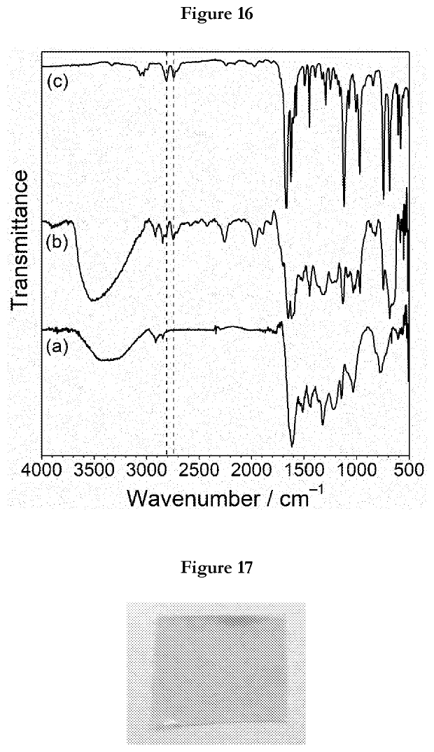

FIG. 16 illustrates the IR spectra of: (a) tea-only coating (RAIRS); (b) tea-cinnamaldehyde (30 mg in 10 ml tea solution) coating (RAIRS); and (c) liquid cinnamaldehyde (ATR);

FIG. 17 illustrates a photograph of PET substrate with green tea-eugenol (30 mg) coating;

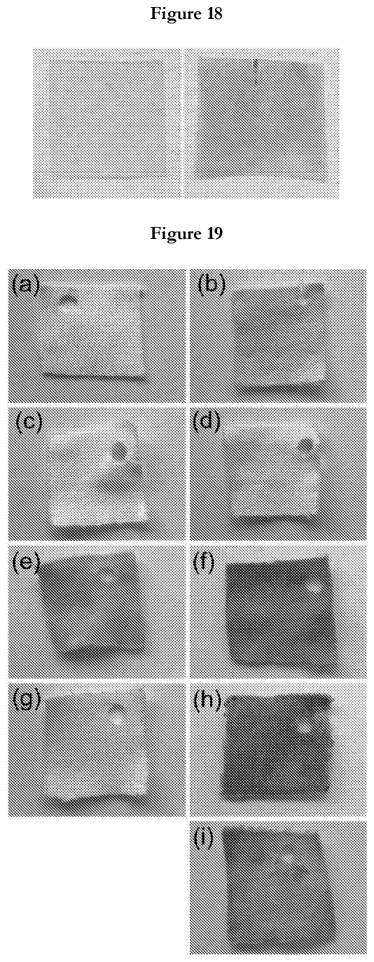

FIG. 18 illustrates photographs of PET substrate: (left) green tea-copper (50 mg) coating; (right) green tea-cinnamaldehyde-copper (50 mg) coating;

FIG. 19 illustrates photographs of cotton substrate: (a) uncoated; (b) tea-only; (c) cinnamaldehyde-only; (d) copper sulphate-only; (e) tea-cinnamaldehyde; (f) tea-copper; (g) cinnamaldehyde-copper sulphate; (h) tea-cinnamaldehyde-copper; and (i) tea-cinnamaldehyde-copper (after washing in ethanol);

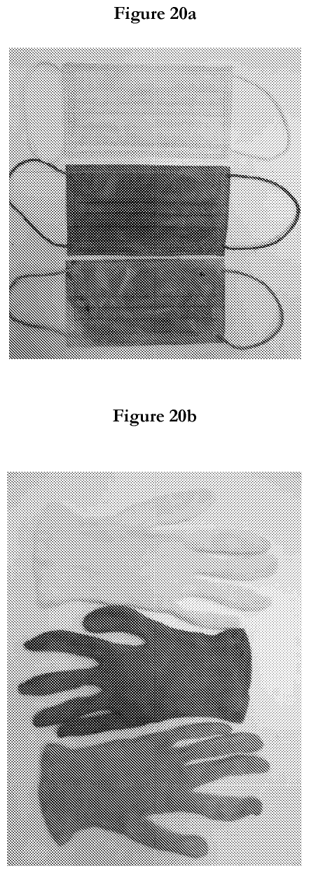

FIGS. 20a-b illustrate photographs of face masks and gloves: (top) untreated; (middle) tea-cinnamaldehyde-silver; and (bottom) tea-cinnamaldehyde-copper;

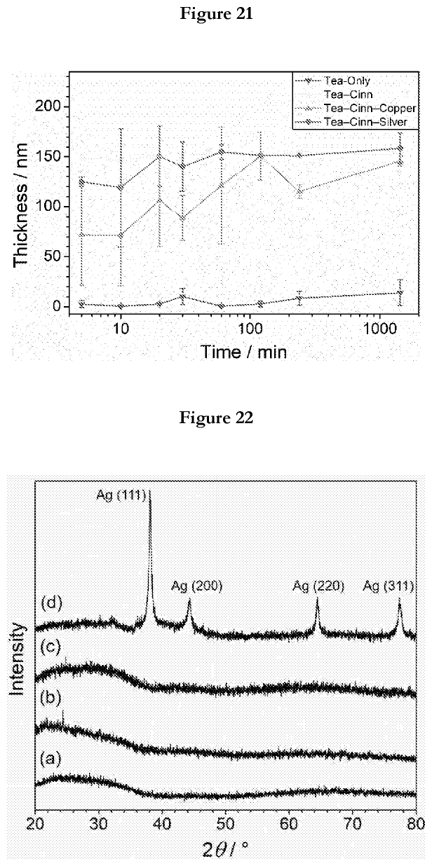

FIG. 21 illustrates the coating thickness on silicon wafer substrate versus deposition time for tea-only, tea-cinnamaldehyde, tea-cinnamaldehyde-copper sulphate pentahydrate, and tea-cinnamaldehyde-silver nitrate coatings. 30 mg cinnamaldehyde and/or 10 mg metal salt added to 10 ml tea solution;

FIG. 22 illustrates XRD diffractograms for glass substrate: (a) uncoated; (b) tea-cinnamaldehyde coating; (c) tea-cinnamaldehyde-copper coating, and (d) tea-cinnamaldehyde-silver coating. 30 mg cinnamaldehyde and 10 mg metal salt added to 10 ml tea solution;

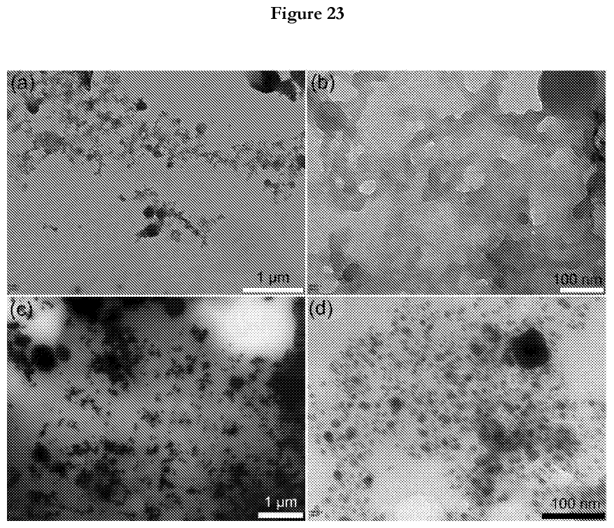

FIG. 23 illustrates transmission electron microscopy (TEM) images of: (a-b) tea-cinnamaldehyde-copper sulphate pentahydrate coating; and (c-d) tea-cinnamaldehyde-silver nitrate coating. 30 mg cinnamaldehyde and 10 mg metal salt added to 10 ml tea solution;

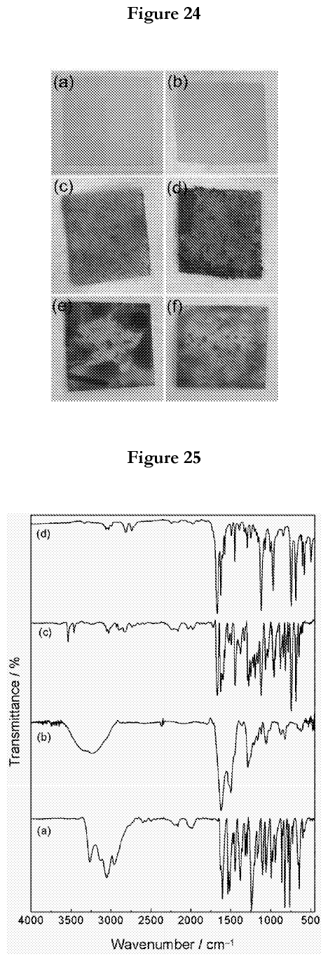

FIG. 24 illustrates photographs of PET: (a) untreated; (b) polynorepinephrine coating; (c) polynorepinephrine-cinnamaldehyde (30 mg) coating; (d) polynorepinephrine-cinnamaldehyde (60 mg) coating; (e) polynorepinephrine-cinnamaldehyde (100 mg) coating; and (f) polynorepinephrine-cinnamaldehyde (150 mg) coating; and

FIG. 25 illustrates the IR spectra of: (a) norepinephrine hydrochloride powder (ATR); (b) polynorepinehprine coating on Si wafer (RAIRS, 66°); (c) polynorepinephrine-cinnamaldehyde (60 mg) coating (ATR); and (d) cinnamaldehyde (ATR).

The present invention provides a range of molecule-containing antibacterial coatings on a number of substrates. Said molecules may be chosen from any of cinnamaldehyde, cinnamaldehyde derivatives, essential oils, or essential oil-derived compounds. Preparations of a number of those coatings are described below and with regard to FIG. 13 there are illustrated two options of embodiments for forming a coating in accordance with the invention.

The present invention also provides a low-cost single-step hybrid coating system utilising brewed tea, cinnamaldehyde essential oil, and a metal salt (of either silver or copper), which utilises the well-known everyday ‘tea cup staining’ phenomenon to ensure good adhesion to a wide range of substrate materials. Compounds contained in tea extract, such as epigallocatechin gallate, are known to exhibit antiviral activity, and have been used in antiviral air filters/cleaners. Tea polyphenols display good binding with SARS-CoV-2 main protease (MPro), making them promising compounds for the inactivation of the virus. In the case of cinnamaldehyde (derived from the oil of cinnamon tree bark), it is also known to exhibit antiviral effects against a variety of viruses. This includes an in silico study demonstrating that cinnamaldehyde exhibits favourable binding with the SARS-CoV-2 spike (S) glycoprotein (which is a key target for antiviral drugs). The tea-cinnamaldehyde-metal coatings described herein offer multi-mode antimicrobial activity, with tea, cinnamaldehyde, and metal constituents all potentially contributing to the observed antimicrobial effects. These tea-cinnamaldehyde-metal coatings require no additional reagents or processes apart from readily available tap water. Tea and cinnamaldehyde (or cinnamon bark oil) are widely available, relatively cheap, and sustainable organic products. Combined with utilisation of low concentrations of metal salts, these coatings can be easily produced anywhere on a large scale and at low cost (for example, remote field hospitals during humanitarian crises and in low-income countries).

Referring firstly to FIG. 13 there is illustrated a general schematic of both the single-step (A) and the multi-step (B) processes described in the present invention on a non-porous substrate 1. In the single-step process, the substrate 1 may have the polymer 3 and molecule-containing 5 layers coated on its surface simultaneously. This may be achieved by the molecule-containing solution and the polymer being mixed and the substrate 1 is subsequently immersed in the mixture, as described in the various examples below. In the alternative multi-step process shown, a polymer is deposited on to the surface of the substrate 1 to functionalise the surface and form the polymer layer 3. Subsequent to this, the functionalised substrate is then exposed, in one embodiment by immersion, in the molecule-containing solution to add the molecule-containing layer 5 and form the coating on the substrate 1. It will be seen that some molecules will bond and others may immediately or over time separate and this allows the coating to be formed with a predictable release rate value for the molecules and so the coating can be formed for specific purposes. For example where the coating is required to perform in the same manner for a prolonged period of time, such as to prevent sticking of materials to the coating and therefore having prolonged hydrophobic properties such as would be required for a coating for an oil pipeline interior wall, a zero release characteristic would be the aim, whereas when the coating is for a base and the benefits from the coating are required to be made available quickly, such as for a biomedical purpose, then a full or quick release characteristic is the aim. It will therefore be appreciated that different have the coating materials and combinations can be selected accordingly.

In one embodiment the molecules which are released may subsequently be replaced with the same molecule type or different molecule types so as to arrive at a coating which has characteristics formed by a combination of different molecule types which are bonded thereto.

### Experimental

### Materials

Silicon wafer (<100> orientation; 5-20 Ω·cm resistivity; 525±25 μm thickness, polished front surface; Silicon Valley Microelectronics Inc.), glass slides (1 mm thickness, Academy Science Ltd.), polyethylene terephthalate film (PET, capacitor grade, 0.10 mm thickness, Lawson Mardon Ltd.), hydrophilic non-woven polypropylene cloth (spunbond, 0.32 mm thickness, 25 g m⁻², Daltex® Absorb, Don & Low Ltd.), and polytetrafluoroethylene sheet (Gilbert Curry Industrial Plastics Co Ltd.) were cut into 15 mm×15 mm pieces and used as substrates for coating. Cotton gloves (product code 1232600, Arco Ltd.), tennis balls (part number DWSQ03002, Slazenger brand, Frasers Group plc.), and personal protection 3-ply non-woven polypropylene face masks (Hygiene & Sicherheit product code 043-06/2019, Goetzloff GmbH) were used as supplied. Substrates were cleaned by immersing into a sufficient quantity so as to fully immerse in a 50:50 volume solvent mixture of propan-2-ol (+95%, Fisher Scientific UK Ltd.) and cyclohexane (+99.5%, Fisher Scientific UK Ltd.) and agitated in an ultrasonic bath for 15 min, before drying in air at 20° C.

### Coating Preparation

Turning now to the coating itself, Polyethylene terephthalate film (PET, capacitor grade, 0.10 mm thickness, Lawsden-Morden Ltd.), non-woven polypropylene cloth (0.41 mm thick, 22.7±4.4 μm fibre diameter, with dimpled structure 0.68±0.16 mm separation, spunbond, 70 g m⁻², Avoca Technical Ltd.), polytetrafluoroethylene microporous membrane (PTFE, Type 3V, surface area 5.6 m², Mupor Ltd.), and knitted cotton fabric (WarwickEquest Ltd.) were cut into 15 mm×15 mm pieces and used as substrates for coating.

Polydopamine-only reference coating solutions were prepared using dopamine hydrochloride (30 mg, 99%, Alfa Aesar brand, Fisher Scientific UK Ltd.) dissolved in aqueous solution of tris(hydroxymethyl)aminomethane buffer (10 ml, 25 mM, pH 8.5, 99.8%, Acros Organics brand, Fisher Scientific UK Ltd.) in a glass vial. Substrates were immediately placed into the vial, the lid closed, and the vials then shaken for 24 hours at 20° C. using an orbital shaker (model Vibrax VXR, IKA Ltd.). Subsequently the substrates were removed and washed with ultrapure water (Type 1, produced by water purification system model Milli-Q Integral 3 Water Purification System, Millipore Ltd.) for 5 minutes whilst shaking, and then dried in air for at least 3 hours at 20° C.

Cinnamaldehyde-only reference solutions were prepared by adding trans-cinnamaldehyde (150 mg equivalent to 1.5 wt % in final solution; 99%, Acros Organics brand, Fisher Scientific UK Ltd.) into a glass vial followed by 10 ml of aqueous tris(hydroxymethyl)aminomethane buffer (25 mM, pH 8.5). Substrates were immediately placed into the vial, the lid closed, and the vials then shaken for 24 hours at 20° C. using an orbital shaker. Subsequently the substrates were removed and washed with ultrapure water for 5 minutes whilst shaking, and then dried in air for at least 3 hours at 20° C.

Polydopamine-cinnamaldehyde solutions were prepared by mixing dopamine hydrochloride (30 mg) and cinnamaldehyde (150 mg) in a glass vial. Aqueous tris(hydroxymethyl)aminomethane (10 ml, 25 mM, pH 8.5) was then added to the vial (i.e. equivalent to 3 mg ml⁻¹ of dopamine hydrochloride, cinnamaldehyde at 1.5 wt % solution, equivalent to a 1:5 mass ratio of dopamine hydrochloride to cinnamaldehyde and a 1:4.5 molar ratio of tris(hydroxymethyl)aminomethane to cinnamaldehyde).

For the polyethyleneimine-cinnamaldehyde coating, a polyethyleneimine solution (2.0 g, 50 wt % aqueous, MW 750,000 Da, branched, Sigma-Aldrich Ltd.) was diluted in 50 ml of water to give a 2 wt % aqueous solution of polyethyleneimine. Cinnamaldehyde (200 mg) and 10 ml of the 2 wt % polyethyleneimine solution were then added to a vial. Control polyethyleneimine-only treated substrates were immersed in the 2 wt % aqueous solution of polyethyleneimine.

For tannic acid-cinnamaldehyde coating solutions, tannic acid (30 mg, Sigma-Aldrich Ltd.) was mixed with cinnamaldehyde (30 mg) in a glass vial. Aqueous tris(hydroxymethyl)aminomethane buffer (10 ml, 25 mM, pH 8.5) was added to the vial (i.e. equivalent to both tannic acid and cinnamaldehyde at 0.3 wt % solution, and a 1:1 weight ratio of tannic acid to cinnamaldehyde). Tannic acid-only coating solutions were similarly prepared by excluding cinnamaldehyde in the procedure.

For each of the aforementioned coating solutions, substrates were immediately placed into the vial, the lid closed, and the vials then shaken for 24 hours at 20° C. using an orbital shaker. Subsequently, the substrates were removed and washed with ultrapure water for 5 minutes whilst shaking, and then dried in air for at least 3 hours at 20° C.

Porous non-woven polypropylene cloth pieces were immersed into 1.5 wt % aqueous suspension of cinnamaldehyde (10 ml) with shaking for 24 hours at 20° C., then removed, and washed in ultrapure water for 5 minutes whilst shaking, before finally drying in air for at least 3 hours at 20° C. PTFE membrane and knitted cotton pieces were immersed into 3.0 wt % aqueous cinnamaldehyde solution (10 ml) with shaking for 24 hours at 20° C., then removed, and rinsed in ultrapure water for 5 minutes whilst shaking, prior to final drying in air for a minimum of 3 hours at 20° C. For all three porous materials, tris(hydroxymethyl)aminomethane was not included in the solutions.

### Antibacterial Testing

The prepared substrates with their respective coatings were subsequently tested for their antibacterial qualities against representative species of Gram-negative and Gram-positive bacteria. Gram-negative Escherichia coli BW25113 (CGSC 7636; rrnB3 ΔlacZ4787 hsdR514 Δ(araBAD)567 Δ(rhaBAD)568 rph-1) and Gram-positive Staphylococcus aureus (FDA209P, an MSSA strain; ATCC 6538P) bacteria cultures were prepared using autoclaved (Autoclave Vario 1528, Dixons Ltd.) Luria-Bertani broth media (LB; L3022, Sigma-Aldrich Ltd., 2% w/v in Milli-Q® grade water). A 5 ml bacterial culture was grown from a single colony for 16 h at 37° C., and then 50 μL used to inoculate a sterile polystyrene cuvette (Catalogue No. 67.742, Sarstedt AG) containing 1 mL of LB Broth. The cuvette was covered with Parafilm (Cole-Parmer Ltd.) and then placed inside a shaking incubator (model Stuart Orbital Incubator S1500, Cole-Parmer Ltd.) set at 37° C. and 120 rpm. An optical density OD₆₀₀ₙₘ=0.4 was verified using a UV-Vis spectrophotometer (model Jenway 6300, Cole-Parmer Ltd.) to obtain bacteria at the mid-log phase of growth.

Uncoated control samples were washed in absolute ethanol for 15 minutes and then dried under vacuum in order to make sure they were sterile and clean. Sterile microtubes (1.5 mL, Sarstedt AG) were loaded with the untreated, or coated substrates. Next, 100 μL of the prepared bacterial culture was placed onto each substrate (so that the microorganisms could interact with one side of the surface), and left to incubate (model Bacterial Incubator 250, LMS Ltd.) for 4 hours at 30° C. Next, 900 μL of autoclaved Luria-Bertani broth media was pipetted into each microtube and vortexed (model Vortex-Genie 2, Scientific Industries Inc.) in order to recover the bacteria as a 10-fold dilution (10⁻¹). Further ten-fold serial dilutions were undertaken to provide 10⁻², 10⁻³, 10⁻⁴, 10⁻⁵ and 10⁻⁶ samples. Colony-forming unit (CFU) plate counting was performed by placing 10 μL drops from each diluted sample onto autoclaved Luria-Bertani Agar solid plates (EZMix™ powder, dust free, fast dissolving fermentation medium, L7533, Sigma-Aldrich Ltd.) and incubated (model Bacterial Incubator 250, LMS Ltd.) for 16 hours at 30° C. The number of colonies visible at each dilution were then counted. All tests were performed in triplicate.

For antibacterial recycling tests the same procedure as described above was followed, with the variation that, following 4 hours incubation, the substrates were taken out from the 10⁻¹ dilution solution microtubes, rinsed with ultrapure water (approximately 50 ml) for 1 minute at 20° C. and then completely air-dried overnight before the next use. Consecutive repeat tests were performed using the same samples, with the mid-log bacterial culture being placed on the same side of the substrate each time. All tests were performed in triplicate.

### Coating Characterization

Infrared spectra were acquired using a FTIR spectrometer equipped with a liquid nitrogen cooled MCT detector (model Spectrum One, PerkinElmer Inc.). Spectra were collected at 4 cm⁻¹ resolution across the 400-4000 cm⁻¹ range and averaged over 265 scans. Attenuated total reflectance (ATR) infrared spectra of samples were acquired using a diamond ATR accessory (model Golden Gate, Graseby Specac Ltd.). Reflection-absorption (RAIRS) measurements utilized a variable angle accessory (Graseby Specac Ltd.) fitted with a KRS-5 polarizer (to remove the s-polarized component) and set at 66°. The infrared spectrum of dried polyethyleneimine was obtained from the supplied polyethyleneimine aqueous solution (following water removal in vacuo).

Ultraviolet-visible (UV-Vis) spectra were collected on a UV-Vis-NIR spectrophotometer (model Cary 5000, Agilent Technologies Inc.). Reference solution samples were analysed in quartz cuvettes with 1 cm path length. Coated samples were prepared by direct application onto quartz substrates (fused quartz plate, thickness=1 mm, UQG Ltd.). For measuring cinnamaldehyde release into aqueous medium, each coated substrate was immersed into a glass jar containing 100 ml of ultrapure water at 20° C., whilst ensuring that the sample was fully submersed below the surface of the water. 1 ml aliquots were removed for UV-Vis analysis at various times. Each aliquot was further diluted with 9 ml of water to give a 10⁻¹ dilution. These diluted aliquots were placed into 1 cm path length quartz cuvettes and analysed using UV-Vis spectroscopy.

Atmospheric pressure solids analysis probe ionisation (ASAP) mass spectrometry was performed in positive ion mode (model Xevo QToF mass spectrometer, Waters Ltd., UK).

### Tea Coatings Preparation

Tannic acid-cinnamaldehyde-metal coatings were made by adding cinnamaldehyde (30 mg), then either silver nitrate or copper sulphate pentahydrate (either 10 mg or 50 mg), and then tannic acid (30 mg) to a glass vial. Aqueous tris(hydroxymethyl)aminomethane solution (10 ml, 25 mM, pH 8.5) was added to the mixture, and a clean substrate (15 mm×15 mm) was immersed into the solution.

Control tannic acid-metal coatings were produced in the same way, but without the addition of cinnamaldehyde. For each of the aforementioned coating solutions, substrates were immediately placed into the vial, the lid closed, and the vials shaken for 24 h at 20° C. using an orbital shaker. Subsequently the substrates were removed and washed with ultrapure water for 5 min whilst shaking, and then placed on a glass slide to dry in air for at least 3 h at 20° C.

Tea coating was produced by brewing one teabag (Clippers organic green tea, obtained from a local supermarket) in 100 ml boiled drinking tap water for 10 min, then 10 ml was transferred to glass vial (while the tea was still hot, approximately 65° C.) and a clean substrate (15 mm×15 mm) was immersed in solution.

Tea-cinnamaldehyde coating was produced by brewing one teabag in 100 ml boiled drinking tap water for 10 min, then 10 ml was transferred to a glass vial (while the tea was still hot, approximately 65° C.) containing cinnamaldehyde (30 mg). The closed glass vial was manually shaken vigorously for 10 s, and then a clean substrate (15 mm×15 mm) was immersed in solution for coating. Tea-eugenol coatings were produced using the same method but with eugenol replacing cinnamaldehyde.

Tea-cinnamaldehyde-metal hybrid coatings were produced by brewing one teabag in 100 ml boiled drinking tap water for 10 min. Cinnamaldehyde (30 mg) and either silver nitrate or copper sulphate pentahydrate (either 10 mg or 50 mg) were added to a glass vial. 10 ml of green tea solution was added to the mixture, and a clean substrate (15 mm×15 mm) was immersed into the solution. Control tea-metal coatings were produced using the same method, but without the addition of cinnamaldehyde. For cotton substrates (30 mm×30 mm), 20 ml of green tea and 60 mg of cinnamaldehyde were used with 50 mg copper sulphate, in order to account for the larger surface area.

A number of further tea-cinnamaldehyde-metal hybrid coatings were fabricated by adding a specified amount of cinnamaldehyde and either copper sulphate pentahydrate (+98%, Sigma-Aldrich Ltd.) or silver nitrate (+99.9%, Apollo Scientific Ltd.) to an appropriately sized container, as detailed in Table 1, below.

TABLE 1
Experimental parameters for fabrication of tea-cinnamaldehyde-metal hybrid coatings.

| | Substrate | | Tap | Brewed | | Metal | |
|---|---|---|---|---|---|---|---|
| Substrate | Dimensions | Teabags | Water/ml | Tea/ml | Cinnamaldehyde/mg | Salt/mg | Container |
| Silicon wafer | 15 mm × | 1 | 100 | 10 | 30 | 10 | Glass vial |
| | 15 mm | | | | | | |
| Glass slides | 76 mm × | 2 | 500 | 500 | 1500 | 200 | Plastic |
| (for photos) | 26 mm | | | | | | Container |
| Glass (for | 15 mm × | 1 | 100 | 10 | 30 | 10 | Glass vial |
| XRD | 15 mm | | | | | | |
| PET film | 15 mm × | 1 | 100 | 10 | 30 | 10 or 50 | Glass vial |
| | 15 mm | | | | | | |
| Hydrophilic | 210 mm × | 2 | 400 | 400 | 600 | 200 | Plastic |
| PP cloth (for | 150 mm | | | | | | Container |
| photos) | | | | | | | |
| Hydrophilic | 210 mm × | 2 | 400 | 400 | 900 | 300 | Plastic |
| PP cloth (for | 150 mm | | | | | | Container |
| antibacterial | | | | | | | |
| testing) | | | | | | | |
| Hydrophilic | 90 mm × | 2 | 400 | 200 | 600 | 200 | Glass jar |
| PP cloth (for | 90 mm | | | | | | |
| leaching) | | | | | | | |
| Polypropylene | — | 2 | 400 | 400 | 900 | 300 | Glass jar |
| face masks | | | | | | | |
| PTFE | 15 mm × | 1 | 100 | 10 | 30 | 10 | Glass vial |
| | 15 mm | | | | | | |
| TEM grids | — | 1 | 100 | 10 | 30 | 10 | Glass vial |
| Cotton | — | 2 | 300 | 300 | 900 | 300 | Glass jar |
| gloves | | | | | | | |
| Tennis balls | — | 2 | 350 | 350 | 788 | 260 | Glass jar |

For each of the different coatings, the vials were left on a shaker at 20° C. for 16 h. The sample was removed and washed in deionised water with shaking at 20° C. for 5 min, then dried in air at 20° C. for at least 3 h. Alternatively, the sample could be dried under vacuum, or in a vacuum oven, or at an elevated temperature.

### Tea Coating Characterization

Coating thicknesses were measured using a spectrophotometer (model nkd-6000, Aquila Instruments Ltd.). Transmittance-reflectance curves (350-1000 nm wavelength range) were acquired for each sample and fitted to a Cauchy model for dielectric materials using a modified Levenberg-Marquardt algorithm.

Infrared spectra were acquired using a FTIR spectrometer equipped with a liquid nitrogen cooled MCT detector (model Spectrum One, PerkinElmer Inc.). Spectra were collected at 4 cm⁻¹ resolution across the 400-4000 cm⁻¹ range and averaged over 100 scans. Attenuated total reflectance (ATR) infrared spectra were acquired using a diamond ATR accessory (model Golden Gate, Graseby Specac Ltd.). Reflection-absorption (RAIRS) measurements utilized a variable angle accessory (Graseby Specac Ltd.) fitted with a KRS-5 polarizer (to remove the s-polarized component) and set at an incidence angle of 66°.

Surface elemental compositions of coatings were measured by X-ray photoelectron spectroscopy (XPS) using an electron spectrometer (model VG ESCALAB II) equipped with a non-monochromated Mg K_{α1,2} X-ray source (1253.6 eV) and a concentric hemispherical analyser. Photoemitted electrons were collected at a take-off angle of 20° from the substrate normal, with electron detection in the constant analyser energy mode (CAE, pass energies of 20 eV and 50 eV for high resolution and survey spectra respectively). Instrument sensitivity (multiplication) factors were C(1s):N(1s):O(1s):Cu(2p):Ag(3d) equals 1.00:0.37:0.35:0.040:0.048 respectively. The core level binding energy envelopes were fitted using Gaussian peak shapes with fixed full-width-half-maxima (fwhm) and linear backgrounds. All binding energies were referenced to the C(1s) —CₓH_{y} hydrocarbon peak at 285.0 eV.

X-ray diffraction (XRD) was performed using copper K_{α1}/K_{α2} radiation (model Bruker AXS D8 Advance, Bruker UK Ltd.) equipped with a PSD detector (brand Lynx-Eye) and with a nickel filter, and variable slits to give a 6 mm beam on the sample. The diffractometer was operated in Bragg-Brentano mode at room temperature. Each diffraction pattern was recorded over a 20 range of 20-80° with a step size of 0.02°, for a total scan time of 30 min. Coated glass slides were analysed.

Transmission electron microscope (TEM) images were taken using a working voltage of 100 kV (Hitachi HT7800 120 kV TEM, Hitachi Ltd.). Tea-based coatings were deposited onto carbon film supported on 200 mesh copper grids (part number AGS160, Agar Scientific Ltd.).

### Metal Leaching

Coated hydrophilic non-woven polypropylene cloths were cut into 20 mm×20 mm pieces and immersed into a glass vial filled with high-purity water (10 ml) for a predetermined time. The cloth was then removed, and nitric acid (70%, SG 1.42, Fisher Scientific UK Ltd.) was added to give a 4% v/v aqueous HNO₃ solution to aid digestion of any leached metal. Control ‘blanks’ were also examined using uncoated pieces of hydrophilic non-woven polypropylene cloth, but otherwise prepared in the same way. Inductively coupled plasma optical emission spectroscopy (ICP-OES) was performed on the resultant acidic solutions using a vertical torch, cyclonic spray chamber, and concentric nebulizer (model iCAP, Thermo Fisher Scientific UK Ltd.). Measurements were taken in the axial mode at the following wavelengths: Cu=219.958 nm, 224.700 nm, 324.754 nm, 327.396 nm; and Ag=224.641 nm, 243.779 nm, 328.068 nm, 338.288 nm.

### Antibacterial Testing

Tea-cinnamaldehyde, tea-cinnamaldehyde-silver nitrate and tea-cinnamaldehyde-copper sulphate coatings were deposited onto hydrophilic non-woven polypropylene cloth (as described above). 15 mm×15 mm pieces of uncoated and coated substrates were cut out for antibacterial testing.

Gram-negative Escherichia coli BW25113 (CGSC 7636; rrnB3 ΔlacZ4787 hsdR514 Δ(araBAD)567 Δ(rhaBAD)568 rph-1) and Gram-positive Staphylococcus aureus (FDA209P, an MSSA strain; ATCC 6538P) bacteria cultures were prepared using autoclaved (Autoclave Vario 1528, Dixons Ltd.) Luria-Bertani broth media (LB; L3022, Sigma-Aldrich Ltd., 2% w/v in grade water). A 5 ml bacterial culture was grown from a single colony for 16 h at 37° C., and then 50 μL used to inoculate a sterile polystyrene cuvette (Part No. 67.742, Sarstedt AG) containing 1 mL of LB Broth. The cuvette was covered with Parafilm (Cole-Parmer Ltd.) and then placed inside a shaking incubator (model Stuart Orbital Incubator S1500, Cole-Parmer Ltd.) set at 37° C. and 120 rpm to allow the bacteria to grow until an optical density OD₆₀₀ₙₘ=0.4 was measured using a UV-Vis spectrophotometer (model Jenway 6300, Cole-Parmer Ltd.) which corresponded to the mid-log phase growth of bacteria.

Antibacterial testing was performed within 24 h of fabricating the coatings. Uncoated control samples were cleaned and sterilized by washing in absolute ethanol for 15 min and drying under vacuum. Each uncoated or coated substrate piece was placed aseptically inside a sterile microtube (1.5 mL, Sarstedt AG) so that the microorganisms could interact with one side of the surface. Next, 100 μL of the prepared bacterial culture was pipetted onto each substrate. In practice, the porous substrates absorbed the liquid so that the entire 15 mm×15 mm area of the samples was permeated by the bacterial suspension. The microtube lid was closed, to prevent the sample drying out, and the tube placed horizontally on a tray and incubated (model Bacterial Incubator 250, LMS Ltd.) for 4 h at 30° C. without shaking. Next, 900 μL of autoclaved Luria-Bertani broth media was pipetted into each microtube and vortexed (model Vortex-Genie 2, Scientific Industries Inc.) in order to recover the bacteria as a 10-fold dilution (10⁻¹). The vortex mixer agitates the samples at 2000-3000 rpm, and is fully capable of removing bacteria from surfaces. The cells were unaffected by vortexing and fully removed from the sample surface, as previously reported. Further ten-fold serial dilutions were undertaken to provide 10⁻², 10⁻³, 10⁻⁴, 10⁻⁵ and 10⁻⁶ samples. Colony-forming unit (CFU) plate counting was performed by placing 10 μL drops from each diluted sample (10⁻¹ to 10⁻⁶ dilutions) onto autoclaved Luria-Bertani Agar solid plates (EZMix™ powder, dust free, fast dissolving fermentation medium, L7533, Sigma-Aldrich Ltd.) and incubated (model Bacterial Incubator 250, LMS Ltd.) for 16 h at 30° C. At each dilution, the number of colonies visible were then counted by eye. All tests were performed in triplicate. The bacterial Log₁₀ Reduction value for a coated sample was calculated relative to the control untreated samples. For each experiment, uncoated and coated substrates were exposed to bacteria in parallel and incubated under identical conditions for the same time period; this was followed by recovery of bacterial cells and viability measurement. This test method to quantify the number of bacteria killed following exposure to coated substrates was chosen because cinnamaldehyde is not readily soluble in aqueous media and therefore its efficacy will be localised at the coating surface. The high numbers of bacteria recovered from untreated substrates provides good evidence that the test method is effective.

### Antiviral Testing

The deposited coatings were tested for their antiviral potency against murine coronavirus (mouse hepatitis virus strain A59, MHV-A59). MHV-A59 is used as a potential surrogate for SARS-CoV-2 (MHV and SARS-CoV-2 belong to the same genus and are structurally similar to each other). Antiviral testing was performed on coatings applied to non-woven fabric face masks using a simulated splash test (modified ISO 18184): Aliquots of viral stocks were thawed on ice. Murine coronavirus (mouse hepatitis virus strain A59, MHV-A59) stock titre used was approximately 1×10⁹ infectious units per ml (titred when prepared). The face mask edges were cut off, and the front face fabric of each mask was separated. 2 cm squares were cut from the front face piece, sterilised by subjecting each surface to 15 min UV irradiation in a Class II MSC, and then placed into sterile plastic Petri dishes. 5×4 μL aliquots of virus were inoculated onto the surface of each of the test materials, and tested in triplicate. Test materials remained within Petri dishes (without lids) inside a Class II Microbiological Safety Cabinet (MSC) at a stable temperature and humidity for the specified contact time (2 h). Contact time began as soon as the inoculum was pipetted onto the surface of the material. At t=0 h and t=2 h, the respective samples were submerged in 0.5 ml of 1.5% (w/v) beef extract in a 50 ml Greiner tube and vortexed vigorously for 10 s. The resultant viral suspensions (eluates) were aseptically collected and 25 μL aliquots diluted by serial 10-fold dilutions in 2.5% FBS DMEM (low glucose, no glutamate). Non-inoculated samples were subject to the same elution and dilution procedures to assay for cytopathic effects associated with the uncoated fabric. 50 μL aliquots of eluted and diluted viral suspensions were added to individual wells of 96-well culture plates containing monolayers of 17Cl-1 cells cultured in 100 μL of the appropriate medium. Viral eluate from each sample was used to inoculate 4 wells of cells, i.e. 12 wells in total for each dilution given triplicate samples. Dilutions ranged from neat eluate through to 10⁻⁶ dilution. The final row of wells/cells was inoculated with sterile culture medium. Assay plates were incubated for up to 48 h at 37° C. in a 5% CO₂ atmosphere. Plates were assessed and scored by microscopy at 24 h intervals for the presence of cytopathic effects (CPE), as evidenced by the presence of gaps in cell confluence and/or detached cells. Wells in which >50% of the cells showed CPE were judged as being positive for TCID50 purposes. The TCID50 (median Tissue Culture Infectivity Dose) value represents the endpoint dilution where 50% of cell monolayers challenged by the eluted virus sample show observable cytopathic effects as a result of infection by the test virus. TCID50 values were calculated via the Reed and Muench method.

Norepinephrine-Cinnamaldehyde Coating Polyethylene terephthalate film (PET, capacitor grade, 0.10 mm thickness, Lawsden-Morden Ltd.), silicon wafers (0.014-0.024 Ωcm resistivity, Silicon Valley Microelectronics Inc.) were cut into 15 mm×15 mm pieces and used as substrates for coating.

Polynorepinephrine-only reference coating solutions were prepared using DL-norepinephrine hydrochloride (30 mg, ≥97%, Sigma-Aldrich Ltd.) dissolved in aqueous solution of tris(hydroxymethyl)aminomethane buffer (10 ml, 25 mM, pH 8.5, 99.8%, Acros Organics brand, Fisher Scientific UK Ltd.) in a glass vial.

Polynorepinephrine-cinnamaldehyde solutions were prepared by mixing DL-norepinephrine hydrochloride (30 mg) and cinnamaldehyde (30 mg, 60 mg, 100 mg, or 150 mg) in a glass vial. Aqueous tris(hydroxymethyl)aminomethane (10 ml, 25 mM, pH 8.5) was then added to the vial, the lid closed, and the vial shaken vigorously by hand for approximately 5 s.

For each of the aforementioned coating solutions, Substrates were immediately placed into the vial containing the solution, the lid closed, and the vials then shaken for 24 h at 20° C. using an orbital shaker (model Vibrax VXR, IKA Ltd.). Subsequently the substrates were removed and washed with deionised water for 5 min whilst shaking, and then placed on a glass slide to dry in air at 20° C. for at least 3 h.

### Results

### Polydopamine-Cinnamaldehyde Coating

For the case of the control cinnamaldehyde-only treatment, the cinnamaldehyde oil sunk to the bottom of the aqueous tris(hydroxymethyl)aminomethane solution in the vial. However, vigorous shaking of the vial for a few seconds turned the solution milky in appearance (opaque white due to the suspension of cinnamaldehyde in water). A slight colour change to yellow was seen in the solution. No solid formation was observed over a period of time, until eventually the cinnamaldehyde constituent slowly coalesced to separate out from the aqueous phase. Immersion of PET film into the polydopamine-only coating solution gave rise to the appearance of a dark grey-black surface layer, FIG. 1. Concurrently over the course of the reaction the polydopamine precursor solution turned from colourless to black within the vial due to precipitate formation.

For the combined polydopamine-cinnamaldehyde system, addition of the aqueous tris(hydroxymethyl)aminomethane solution to the dopamine hydrochloride and cinnamaldehyde solid-liquid mixture led to the dopamine hydrochloride dissolving, and the cinnamaldehyde settled at the bottom of the vial. After vigorous shaking of the vial for a few seconds, the solution turned milky in appearance (due to the suspension of cinnamaldehyde in the aqueous medium—as described above), see FIG. 1. Over time, the white cloudiness faded away. However, no black colouration indicative of polydopamine was observed at any point during the reaction—neither on the substrates, nor in the solution. Instead, the white cloudiness disappeared to give a clear solution with a slight yellow colour. This was accompanied by the formation of a red coating on the substrates (as well as on the vial bottoms), FIG. 1. The mass increase of PET film following polydopamine-cinnamaldehyde coating was measured to be 4.4±0.9 mg cm⁻² (assuming both sides are coated), see Table 2, below. A range of different substrates could be coated by this method, including PET, polypropylene, silicon wafer, and glass.

TABLE 2
Mass increase for polydopamine-cinnamaldehyde, polyethyleneimine-
cinnamaldehyde, and tannic acid-cinnamaldehyde coated non-
porous PET film substrates, and cinnamaldehyde treated non-
woven polypropylene cloth. 15 mm × 15 mm sample size.

| | Mass |
|---|---|
| Coating | Increase/mg cm⁻² |
| Polydopamine-Cinnamaldehyde/PET Film | 4.4 ± 0.9 † |
| Polyethyleneimine-Cinnamaldehyde/PET Film | 0.7 ± 0.3 † |
| Tannic Acid-Cinnamaldehyde/PET Film | 1.0 ± 0.2 † |
| Cinnamaldehyde/Non-Woven Polypropylene Cloth | 45 ± 4 |

† Assuming both sides are coated.

Cinnamaldehyde oil and the polydopamine-cinnamaldehyde coatings were characterised by infrared spectroscopy, see FIG. 2. Note also in FIG. 2 that Schiff base imine absorbance should appear around 1640 cm⁻¹—this absorbance is not distinguishable due to overlap with strong cinnamaldehyde peaks. Liquid cinnamaldehyde absorption bands include aromatic and alkene C—H stretching (around 3060 cm⁻¹), aldehyde C—H stretching (2814 and 2742 cm⁻¹), C═O stretching (1668 cm⁻¹), as well as aromatic C═C stretching (1625 cm⁻¹). Polydopamine-only coated silicon wafer displayed broad absorbances around 3220 cm⁻¹ corresponding to O—H groups, and 1605 cm⁻¹ and 1509 cm⁻¹ from C═C stretching. For the case of polydopamine-cinnamaldehyde coated silicon wafer, the characteristic cinnamaldehyde absorbances were still visible, as well as a broad polydopamine O—H group absorption around 3220 cm⁻¹, together with a small polydopamine aromatic C═C stretching peak at 1509 cm⁻¹ (both of these latter features are absent for pure cinnamaldehyde).

Cinnamaldehyde displays an intense UV-Vis absorbance peak at λ=290 nm, but no other features, see FIG. 3. Polydopamine coated quartz showed a weaker UV-Vis absorbance peak at λ=290 nm, as well as broad absorption across the 200-800 nm wavelength range, FIG. 3. Polydopamine-cinnamaldehyde coated quartz exhibited a strong absorbance at λ=288 nm, which can be attributed to either or both of the cinnamaldehyde and dopamine coating constituents. In addition, a new absorbance peak at λ=438 nm is apparent (which was absent in both the aforementioned cinnamaldehyde and polydopamine UV-Vis spectra)—this accounts for the observed red coating colour and is indicative of chemical bond formation (reaction) between polydopamine and cinnamaldehyde causing a change in electron density within the host polydopamine structure (hence UV-Vis excitation).

It had previously been understood that polydopamine can undergo an Aza-Michael reaction with acrylate groups, where the polydopamine amine group nitrogen lone pair attacks the carbon-carbon double bond of the acrylate group to form a new bond. Given that cinnamaldehyde contains an alkene bond adjacent to a carbonyl group, an analogous Michael or Aza-Michael type reaction may be anticipated. However, other studies have shown that an amine group nitrogen lone pair can react via nucleophilic attack at the cinnamaldehyde carbonyl group to form a Schiff base imine product. Therefore, in order to elucidate the reaction mechanism for exactly how cinnamaldehyde reacts with dopamine/polydopamine, a mass spectrometric investigation was undertaken: cinnamaldehyde was reacted with an equimolar amount of phenethylamine—a compound analogous to dopamine but lacking the catechol OH groups (thereby unable to undergo polymerisation as observed for dopamine), see Scheme 1 below, which illustrates the reaction of cinnamaldehyde with phenethylamine to form a Schiff base imine product. The obtained product was a viscous orange oil. Mass spectrometry of the product gave mass 236.1 m/z (which is consistent with the empirical formula C₁₇H₁₇N and the Schiff base imine product molecular ion [M+H]⁺). No mass fragment was measured for the alternative Michael addition product ion expected at 253 m/z. Hence, cinnamaldehyde reacts with dopamine/polydopamine to form a Schiff base imine product. Tris(hydroxymethyl)aminomethane was not included in this reaction in order that only the reaction between phenethylamine and cinnamaldehyde could be investigated. Although tris(hydroxymethyl)aminomethane has been reported to react with polydopamine during coating deposition, this does not occur via the Schiff base reaction. There also is in addition the possibility of tris(hydroxymethyl)aminomethane undergoing the Schiff base reaction with cinnamaldehyde to form imine linkages.

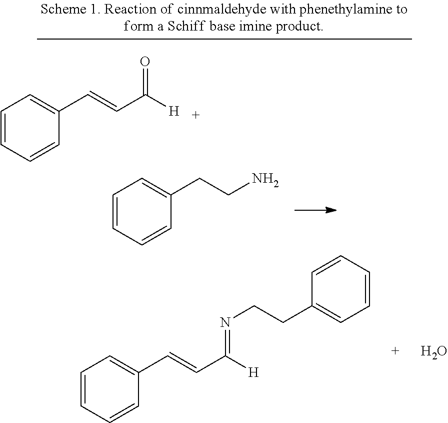 [SMILES: O=C/C=C/c1ccccc1 ; NCCc1ccccc1 ; C(=C\c1ccccc1)/C=N/CCc1ccccc1 ; O]

With regard to scheme 1 above it should also be appreciated that the combination of the linkages could be reversed.

Control cinnamaldehyde treated PET samples had a very small antibacterial effect against both Gram-negative E. coli and Gram-positive S. aureus (this could be due to a low amount of residual cinnamaldehyde remaining on the PET film surface after final washing), see Table 3 below. Polydopamine-coated PET film showed no antibacterial activity against E. coli and a very minor effect for S. aureus (less than Log 10 reduction=1). Whereas, polydopamine-cinnamaldehyde coated PET film displayed complete killing of both types of bacteria (exceeding Log 10 reduction=8); and this activity was retained during recycling tests against E. coli for the first two tests, followed by a gradual loss of efficacy during further recycling, see FIG. 4. Note also in FIG. 4 that Log₁₀ reduction values are calculated relative to the untreated PET substrate (mean±standard deviation). Samples were rinsed with water for 1 min at 20° C. and completely airdried prior to the next re-use.

TABLE 3
Antibacterial activities for PET film coated with: polydopamine;
polydopamine-cinnamaldehyde; polyethyleneimine-cinnamaldehyde;
tannic acid; or tannic acid-cinnamaldehyde. Log10 reduction
values are calculated relative to the untreated substrate
(mean ± standard deviation).

| | Bacteria Loss/Log₁₀ Reduction | |
|---|---|---|
| | E. coli | S. aureus |
| Dipping Solution | (Gram-negative) | (Gram-positive) |
| Cinnamaldehyde † | 0.12 ± 0.07 | 0.29 ± 0.07 |
| Polydopamine † | 0.00 | 0.34 ± 0.00 |
| Polydopamine-Cinnamaldehyde | 9.15 ± 0.03 | 8.68 ± 0.05 |
| Polyethyleneimine † | 0.00 | 0.00 |
| Polyethyleneimine- | 3.87 ± 0.56 | 8.44 ± 0.03 |
| Cinnamaldehyde | | |
| Tannic Acid † | 0.00 | 0.13 ± 0.07 |
| Tannic acid-Cinnamaldehyde | 9.33 ± 0.03 | 8.56 ± 0.06 |

† Control samples comprised immersion of PET film in 1.5 wt % cinnamaldehyde aqueous solution, or 2 wt % polyethyleneimine aqueous solution, or 0.3 wt % tannic acid aqueous solution followed by rinsing in water.

In order to further examine the mechanism of antibacterial activity, time-resolved UV-Vis spectroscopy studies were performed using the polydopamine-cinnamaldehyde coated PET film, see FIG. 5. The cinnamaldehyde release into water from the host coating showed a rapid increase followed by levelling off after 24 hours. This is consistent with the antibacterial recycle testing, which shows a gradual drop-off in activity shown in FIG. 4.

### Polyethyleneimine-Cinnamaldehyde Coating

Polyethyleneimine was utilised to develop further understanding, given that it contains amine groups like polydopamine, and therefore polyethyleneimine should undergo the Schiff base reaction with cinnamaldehyde to form an antibacterial coating, FIG. 10. Solution mixtures utilising varying ratios of polyethyleneimine to cinnamaldehyde were screened in order to determine optimal quantities of both components for the production of a high efficacy antibacterial coating. Mixing of polyethyleneimine solution with cinnamaldehyde led to the formation of an off-white precipitate which was found to uniformly adhere to the test substrates (as well as to the bottom of the glass vials), and remained unchanged in appearance following washing with water. For formulations where a higher weight proportion of polyethyleneimine relative to cinnamaldehyde was used, much less precipitate was found to form. Whereas excess cinnamaldehyde compared to polyethyleneimine led to a yellow solution, and practically no adhesive precipitate observed on substrate. Equal masses of polyethyleneimine and cinnamaldehyde yielded good performance coatings (2 wt % polyethyleneimine and 2 wt % cinnamaldehyde mixture solutions were chosen for further studies). The mass increase following coating of PET substrates was measured to equal 0.71 mg cm⁻² (assuming both sides are coated), see Table 2.

Infrared absorption peaks for polyethyleneimine include N—H stretching (3275 cm⁻¹), aliphatic C—H stretching (2930-2810 cm⁻¹), primary amine group NH₂ bending (1580 cm⁻¹), and CH₂ symmetric bending vibration (1460 cm⁻¹), see FIG. 6. The polyethyleneimine-cinnamaldehyde coating showed a broad absorption peak around 3300 cm⁻¹, corresponding to N—H stretching. A new feature at 1634 cm⁻¹ is present, marked by the asterisk, consistent with imine bond formation following the Schiff base reaction between amine groups from polyethyleneimine and cinnamaldehyde (akin to the reactions between phenethylamine/polydopamine and cinnamaldehyde), as per Scheme 1. Otherwise, many of the infrared fingerprint region absorption bands of cinnamaldehyde and polyethyleneimine overlap with the polyethyleneimine-cinnamaldehyde spectrum.

PET films immersed in polyethyleneimine-only 2 wt % aqueous solution followed by washing in ultrapure water and drying for at least 3 hours at 20° C. were tested as a control and found to possess no antibacterial activity, Table 3. Whereas, the polyethyleneimine-cinnamaldehyde coated PET films showed at least Log₁₀ reduction=3 or 4 against E. coli, and complete killing (exceeding Log₁₀ reduction=8) for S. aureus. Antibacterial recycling tests were carried out against E. coli, and there was a drop in bacterial killing following the second test with practically all biocidal activity lost after the fourth test, FIG. 4.

The release behaviour of the polyethyleneimine-cinnamaldehyde coating in water was further investigated by immersion of coated PET substrates into water for 24 hours at 20° C. whilst shaking. 0.5±0.4 mg cm⁻² of material was released after 24 hours, and 0.22±0.14 mg cm⁻² of the coating remained. Visually, there did not seem to be any alteration to the appearance of the coatings. This would suggest that the observed mass loss following immersion in water for 24 hours is due to the release of trapped or loosely bound cinnamaldehyde and/or polyethyleneimine.

Time-resolved UV-Vis spectroscopy studies were performed using the polyethyleneimine-cinnamaldehyde coated PET films in order to determine the release profile of cinnamaldehyde into aqueous solution from the coating, FIG. 5. A much lower cinnamaldehyde absorbance was measured compared to the polydopamine-cinnamaldehyde system, which is consistent with the polyethyleneimine-cinnamaldehyde coating being a lot thinner and thereby losing its recycling antibacterial activity faster compared to the polydopamine-cinnamaldehyde coating, as per Table 2 and FIG. 4.

### Tannic Acid-Cinnamaldehyde Coating

Tannic acid-only coatings were found to be very thin; whilst tannic acid-cinnamaldehyde coatings appeared to be much thicker. Variation in tannic acid-cinnamaldehyde solution composition was explored in order to provide the optimum coating: 0.30, 0.45, 0.60, and 1.5 wt % cinnamaldehyde combined with fixed 0.3 wt % tannic acid (corresponding to a tannic acid:cinnamaldehyde mass ratio of 1:1, 1:1.5, 1:2, and 1:5 respectively). The solid coating obtained using a 1:1 mass ratio was yellow in appearance and evenly covered the PET film, whereas all of the other solution compositions yielded oily (non-solid), non-uniform coatings on the PET film surfaces, shown in FIG. 7. Hence, 0.3 wt % cinnamaldehyde-0.3 wt % tannic acid mixture solution was chosen for further investigation. The mass increase for the tannic acid-cinnamaldehyde coating was 1.0±0.2 mg cm⁻² (assuming both sides of each substrate are coated), as per Table 2.

The infrared spectrum of tannic acid displays absorbances for O—H groups (3300 cm⁻¹), C═O stretching (1700 cm⁻¹), and three peaks at 1605 cm⁻¹, 1530 cm⁻¹ and 1444 cm⁻¹ associated with aromatic ring stretching, see FIG. 8. For the tannic acid-cinnamaldehyde coating, the infrared spectrum resembles the tannic acid spectrum. In addition, there is a new absorbance at 1649 cm⁻¹, marked by the asterisk, characteristic of imine group C═N stretching (which appears at a lower wavenumber compared to the cinnamaldehyde C═O stretching vibration (1670 cm⁻¹)). An explanation for this new imine peak could be the Schiff base reaction product between tris(hydroxymethyl)aminomethane and cinnamaldehyde (this may also explain the formation of yellow colour in the cinnamaldehyde control solution mentioned previously—the cinnamaldehyde and tris(hydroxymethyl)aminomethane) react to form a yellow Schiff base imine product). It had previously been reported that tris(hydroxymethyl)aminomethane can undergo Schiff base reaction with carbonyl-containing compounds, yielding C═N infrared stretching frequencies in the region of 1640-1630 cm⁻¹. Tris(hydroxymethyl)aminomethane and cinnamaldehyde are present in almost equimolar amounts in the tannic acid-cinnamaldehyde coating solution, whereas in the polydopamine-cinnamaldehyde coating solution there is a clear excess of cinnamaldehyde relative to tris(hydroxymethyl)aminomethane (which masks the imine bond region of the infrared absorption). Tannic acid is also capable of reacting with amines via the Schiff base reaction to form an imine; however, the wavenumber for such imine group stretching should be much lower (1585 cm⁻¹), thus making it unlikely that this new peak is due to the reaction of tannic acid with tris(hydroxymethyl)aminomethane to form an imine.

Tannic acid-only coated PET film displayed no antibacterial activity against E. coli and only a modest reduction in viability against S. aureus, Table 3. The tannic acid-cinnamaldehyde coating was found to give rise to complete killing of both types of bacteria (exceeding Log₁₀ reduction=8). Antibacterial recycling tests performed with E. coli for the tannic acid-cinnamaldehyde coated PET film showed a decrease in antibacterial activity after the first test, and by the fifth test showed negligible activity, FIG. 4. A possible reason for why the tannic acid-cinnamaldehyde coating does not display as long-lasting antibacterial activity as the polydopamine-cinnamaldehyde coating could be as a consequence of the smaller amount of cinnamaldehyde used to prepare the coatings (0.3 wt % versus 1.5 wt % solutions respectively), or due to the coating being thinner, Table 2.

Time-resolved UV-Vis spectroscopy studies were performed using tannic acid-cinnamaldehyde coated PET film in order to follow the release of cinnamaldehyde from the coating into the aqueous phase, FIG. 5. The amount of cinnamaldehyde release measured for the tannic acid-cinnamaldehyde coatings was lower compared to the polydopamine-cinnamaldehyde coatings, and can be attributed to the smaller concentration of cinnamaldehyde employed to prepare the former (0.3 wt % versus 1.5 wt % solutions respectively), or because the coating is thinner, Table 2. This correlates with the antibacterial recycling tests, where the tannic acid-cinnamaldehyde coated PET film showed a faster decline in antibacterial activity relative to the polydopamine-cinnamaldehyde coated PET film, FIG. 4.

### Functionalised Surface-Cinnamaldehyde Coating

A solid surface is made compatible by surface functionalisation for bioactive agent containment and subsequent release. The substrate surface can be functionalised by a range of different techniques, including for example thermal chemical vapour deposition, plasma polymerization, chemical vapour deposition (CVD), initiated chemical vapour deposition (iCVD), plasma enhanced chemical vapour deposition (PECVD), liquid spray deposition, excited liquid spray deposition, photodeposition, ion-assisted deposition, electron beam polymerization, gamma-ray polymerization, target sputtering, atomic layer deposition (ALD), graft polymerization, surface coupling reactions, or solution phase polymerization.

In an embodiment, the substrate surface is functionalised by plasma enhanced chemical vapour deposition (PECVD). A cylindrical glass reactor (5.5 cm diameter, 475 cm³ volume) housed within a Faraday cage was used for plasmachemical surface functionalisation. This was connected to a 30 L min⁻¹ rotary pump (model E2M2, Edwards Vacuum Ltd.) via a liquid nitrogen cold trap (base pressure less than 2×10⁻³ mbar and air leak rate better than 6×10⁻⁹ mol s⁻¹). A copper coil wound around the reactor (4 mm diameter, 10 turns, located 10 cm downstream from the gas inlet) was connected to a 13.56 MHz radio frequency (RF) power supply via an L-C matching network. A signal generator, made in-house, was used to trigger the RF power supply. Prior to film deposition, the whole apparatus was thoroughly scrubbed using detergent and hot water, rinsed with propan-2-ol (+99.5 wt. %, Fisher Scientific UK Ltd.), oven dried at 423 K, and further cleaned using a 50 W continuous wave air plasma at 0.2 mbar for 30 min. Silicon substrate preparation comprised successive sonication in propan-2-ol and cyclohexane (+99.7 wt. %, Sigma-Aldrich Ltd.) for 15 min prior to insertion into the centre of the chamber. Further cleaning entailed running a 50 W continuous wave air plasma at 0.2 mbar for 30 min prior to film deposition. Polyethylene terephthalate film (PET, capacitor grade, 0.10 mm thickness, Lawsden-Morden Ltd.) was rinsed in absolute ethanol (+99.5 wt. %, Fisher Scientific UK Ltd.) for 15 min prior to insertion into the centre of the chamber. 4-vinylaniline (97%, Sigma-Aldrich Ltd.) precursor was loaded into a sealable glass tube, degassed via several freeze-pump-thaw cycles, and then attached to the reactor. Monomer vapour was then allowed to purge the apparatus at a pressure of 0.11 mbar, and at a temperature of 313 K (40° C.), for 15 min prior to electrical discharge ignition. Pulsed plasma deposition was performed at 313 K using a duty cycle on-period (tₒₙ) of 100 μs and a duty cycle off-period (t_{off}) of 4 ms in conjunction with a RF generator power output (Pₒₙ) of 40 W. Initially, a continuous wave plasma was run for 30 s before switching to pulsed mode. Plasma depositions were run for a total of 20 min. Upon plasma extinction, the precursor vapour was allowed to continue to pass through the system for a further 15 min, and then the chamber was evacuated to base pressure followed by venting to atmosphere.

Cinnamaldehyde (99%, Acros Organics brand, Fisher Scientific UK Ltd.), citral (95%, mixture of isomers, Acros Organics brand, Fisher Scientific UK Ltd.), decanal (>98%, Mystic Moments Madar Corporation Ltd.), and 2-methylundecanal (>98%, Mystic Moments Madar Corporation Ltd.) were used as compound liquids. Liquid-containing coatings were prepared by adding 100 mg of compound to a glass vial with 10 ml ultrapure water (Type 1, produced by water purification system model Milli-Q Integral 3 Water Purification System, Millipore Ltd.). The solutions were shaken vigorously for 5 seconds to suspend the compound liquid in aqueous solution. Poly(4-vinylaniline) coated substrates (15×15 mm) were immediately immersed into the solution, and the lid was secured on the vial. Then the vials were shaken using an orbital shaker (model Vibrax VXR, IKA Ltd.) for 24 h at 20° C. Afterwards, the substrates were removed from solution, placed in ultrapure water and shaken for 5 min before removal and drying in air for at least 3 h at 20° C.

Control substrates for antibacterial testing were produced by immersing untreated PET into cinnamaldehyde aqueous suspension in the same way.

Sessile drop static contact angle measurements were carried out at 20° C. using a video capture apparatus in combination with a motorised syringe (model VCA 2500XE, A.S.T. Products Inc.). 1.0 μl droplets of ultrapure water were employed as probe liquids for hydrophobicity. Advancing and receding contact angle values were determined by respectively increasing the dispensed 1.0 μl liquid drop volume by a further 1.0 μl, and then decreasing the liquid drop volume by 1.0 μl. Measurements were repeated at least 3 times.

Sliding angle measurements were carried out at 20° C. using an adjustable angle gauge (Arc Euro Trade Ltd.). Samples were placed onto the stage with an initial angle of 0°. A 50 μl droplet of ultrahigh-purity water was dispensed onto the sample, and the tilt angle was subsequently slowly increased until movement was observed in the water droplet. Measurements were repeated at least 3 times.

Gram-negative Escherichia coli BW25113 (CGSC 7636; rrnB3 ΔlacZ4787 hsdR514 Δ(araBAD)567 Δ(rhaBAD)568 rph-1) and Gram-positive Staphylococcus aureus (FDA209P, an MSSA strain; ATCC 6538P) bacteria cultures were prepared using autoclaved (Autoclave Vario 1528, Dixons Ltd.) Luria-Bertani broth media (LB; L3022, Sigma-Aldrich Ltd., 2% w/v in grade water). A 5 ml bacterial culture was grown from a single colony for 16 h at 37° C., and then 50 μL used to inoculate a sterile polystyrene cuvette (Catalogue No. 67.742, Sarstedt AG) containing 1 mL of LB Broth. The cuvette was covered with Parafilm (Cole-Parmer Ltd.) and then placed inside a bacterial incubator shaker (model Stuart Orbital Incubator S1500, Cole-Parmer Ltd.) set at 37° C. and 120 rpm. An optical density OD₆₀₀ₙₘ=0.4 was verified using a UV-Vis spectrophotometer (model Jenway 6300, Cole-Parmer Ltd.) to obtain bacteria at the mid-log phase of growth.

Uncoated control samples were washed in absolute ethanol for 15 min and then dried under vacuum in order to make sure they were sterile and clean. Sterile microtubes (1.5 mL, Sarstedt AG) were loaded with the untreated, or coated substrates. Next, 100 μL of the prepared bacteria solution was placed onto each substrate (so that the microorganisms could interact with one face of the surface), and left to incubate (model Bacterial Incubator 250, LMS Ltd.) for 4 h at 30° C. Next, 900 μL of autoclaved Luria-Bertani broth media was pipetted into each microtube and vortexed (model Vortex-Genie 2, Scientific Industries Inc.) in order to recover the bacteria as a 10-fold dilution (10⁻¹). Further ten-fold serial dilutions were undertaken to provide 10⁻², 10⁻³, 10⁻⁴, 10⁻⁵ and 10⁻⁶ samples. Colony-forming unit (CFU) plate counting was performed by placing 10 μL drops from each diluted sample onto autoclaved Luria-Bertani Agar solid plates (EZMix™ powder, dust free, fast dissolving fermentation medium, L7533, Sigma-Aldrich Ltd.) and incubated (model Bacterial Incubator 250, LMS Ltd.) for 16 h at 30° C. The number of colonies visible at each dilution were then counted. All tests were performed in triplicate.

XPS analysis of pulsed plasma deposited poly(4-vinylaniline) coated silicon wafers detected carbon, nitrogen and a small quantity of oxygen, see Table 4.

TABLE 4
XPS relative atomic compositions of pulsed
plasma deposited poly(4-vinylaniline).

| | C/% | N/% | O/% |
|---|---|---|---|
| Theoretical | 88.9 | 11.1 | 0 |
| Pulsed plasma poly(4-vinylaniline) | 86.7 ± 0.3 | 10.6 ± 0.1 | 2.6 ± 0.5 |

The poly(4-vinylaniline) coated PET substrates were treated with either cinnamaldehyde, citral, decanal, or 2-methylundecanal.

Contact angle measurements of the liquid compound-containing poly(4-vinylaniline) coated surfaces on PET showed small water contact angle hysteresis (hydrophobicity) compared to the relatively large contact angle hysteresis observed for the untreated PET or poly(4-vinylaniline)-coated PET substrates, see Table 5. The citral-containing surface coating gave the lowest contact angle hysteresis, cinnamaldehyde- and decanal-containing surface coatings gave similar hysteresis values (within error), and 2-methylundecanal-containing surface showed the largest contact angle hysteresis of the four liquid compound-containing surfaces.

TABLE 5
Static, receding, and advancing water contact angles, and contact angle hysteresis
for liquid-containing coatings prepared using plasma deposited poly(4-vinylaniline).
Uncoated PET and plasma poly(4-vinylaniline) coated PET are included as controls.
Values are given as mean ± standard deviation.

| | Contact Angle/° | | | |
|---|---|---|---|---|
| Surface | Static | Receding | Advancing | Hysteresis |
| PET control | 66.8 ± 1.6 | 24 ± 3 | 76 ± 2 | 52 ± 3 |
| Plasma deposited poly(4- | 75 ± 6 | 23 ± 3 | 89.3 ± 0.7 | 66 ± 3 |
| vinylaniline) control | | | | |
| Cinnamaldehyde-containing | 56.6 ± 0.1 | 55.1 ± 0.9 | 57.9 ± 0.5 | 2.8 ± 0.8 |
| plasma deposited poly(4- | | | | |
| vinylaniline) | | | | |
| Citral containing plasma | 67.3 ± 0.7 | 67.9 ± 0.2 | 69.6 ± 0.1 | 1.7 ± 0.1 |
| deposited poly(4-vinylaniline) | | | | |
| Decanal containing plasma | 72.6 ± 0.9 | 70.8 ± 1.0 | 75.4 ± 1.3 | 4 ± 2 |
| deposited poly(4-vinylaniline) | | | | |
| 2-Methylundecanal containing | 80.0 ± 1.4 | 74.0 ± 1.2 | 82.8 ± 0.5 | 8.8 ± 0.9 |
| plasma deposited poly(4- | | | | |
| vinylaniline) | | | | |

Sliding angles of water on the liquid compound-containing contains showed relatively low sliding angles compared with the uncoated PET control and the poly(4-vinylaniline) coated PET control (which showed no droplet movement even at 90° inclination), see Table 6. Cinnamaldehyde-containing surface showed the lowest sliding angle, and the citral-, decanal-, and 2-methylundecanal-containing surface showed similar sliding angles (within error).

TABLE 6
Sliding angles of water droplets (50 μl) for liquid-containing
coatings prepared using plasma deposited poly(4-vinylaniline).
Uncoated PET and poly(4-vinylaniline) coated PET are included
as controls. Values are given as mean ± standard deviation.

| Surface | Sliding Angle/° |
|---|---|
| PET control | 48 ± 2 |
| Plasma deposited poly(4-vinylaniline) control | 90 (*) |
| Cinnamaldehyde-containing plasma deposited | 9.7 ± 0.5 |
| poly(4-vinylaniline) | |
| Citral containing plasma deposited poly(4- | 12.3 ± 1.7 |
| vinylaniline) | |
| Decanal containing plasma deposited poly(4- | 13.3 ± 1.3 |
| vinylaniline) | |
| 2-Methylundecanal containing plasma deposited | 14 ± 2 |
| poly(4-vinylaniline) | |

(*) Plasma poly(4-vinylaniline) coated PET samples showed no droplet movement at 90°.

Following multiple uses, the liquid repellency can be regenerated by immersing the molecule derivatised plasma polymer sample into the respective molecule-containing solution for 5 min (for example cinnamaldehyde, or citral, then washed in water for 5 min with shaking.

Less volatile compounds retained their liquid repellency for long periods of time. For example, decanal, and methylundecanal display liquid repellency after 5 months storage in air.

Cinnamaldehyde-containing plasma deposited poly(4-vinylaniline) surface was tested for its antibacterial activities against Gram-negative E. coli and Gram-positive S. aureus. PET substrates treated with cinnamaldehyde-only showed a very small effect against E. coli and S. aureus. This could be due to a small residual amount of cinnamaldehyde remaining on the surface after washing and drying. Poly(4-vinylaniline) coated PET substrates produced a very small reduction (Log₁₀ reduction less than 1) against both E. coli and S. aureus. The plasma poly(4-vinylaniline)—cinnamaldehyde coated PET substrates showed strong antibacterial activity, giving complete killing of both bacteria (Log₁₀ reduction greater than 8).

TABLE 7
Antibacterial tests for polypropylene film coated with plsama poly(4-
vinylaniline)-cinnamaldehyde. Log reduction values are relative
to the untreated substrate (average ± standard deviation).

Log₁₀ Reduction

| Coating | E. coli | S. aureus |
|---|---|---|
| Cinnamaldehyde-only † | 0.12 ± 0.07 | 0.29 ± 0.07 |
| Plasma poly(4-vinylaniline)-only † | 0.19 ± 0.08 | 0.08 ± 0.09 |
| Plasma poly(4-vinylaniline)- | 9.04 ± 0.04 | 8.44 ± 0.03 |
| Cinnamaldehyde | | |

† Control samples.

As mentioned above, and as can be seen in the photographs of FIG. 11, the left half of each plate shows control untreated PET film results, and the right half of each plate shows plasma poly(4-vinylaniline)-cinnamaldehyde coated PET substrates results (no bacteria observed due to complete killing).

Pulsed plasma deposited poly(4-vinylaniline) coated glass vials were treated with either cinnamaldehyde, citral, decanal, or 2-methylundecanal. Subsequent filling of the glass vials with honey or ketchup and then pouring out resulted in complete emptying of the glass vials with no honey or ketchup remaining in the glass vials. As well as providing full dispensation of the food contents, there is the added advantage of providing an antimicrobial container attributable to non-toxic antimicrobial essential oils. Other combinations of functional polymer coatings containing added molecules can also be used for the complete emptying of liquid or liquid-containing filled containers.

### Mixed Coating Solutions

The utilisation of polyphenol-containing solutions such as fruit juice, red wine, cacao, chocolate, tea, mixed with bioactive molecule containing materials such as essential oil plants, spices, and herbs or combinations thereof to form bioactive coatings. Examples include tumeric, paprika, black pepper, coriander, fennel, ginger, cardamom, cinnamon, nutmeg, cloves, oregano, garlic, anise, etc.

### Tea-Cinnamaldehyde Coating Example

Green tea coating was produced by brewing one teabag in 100 ml boiled drinking tap water for 10 min, then 10 ml transferred to a glass vial containing a clean silicon wafer allowing complete immersion in the tea liquid. Lid closed and left to stand overnight (16 h) on shaker at 20° C. Coated silicon wafer was removed and washed in deionised water with shaking for 5 min at 20° C., then dried in air for at least 3 h.

Green tea-cinnamaldehyde coating was produced by brewing one teabag in 100 ml boiled drinking tap water for 10 min, then 10 ml transferred to a glass vial containing cinnamaldehyde (50 mg) and clean silicon wafer allowing complete immersion in solution. Lid closed, sample shaken vigorously for 5 s, and left to stand overnight (16 h) on shaker at 20° C. Coated silicon wafer was removed and washed in deionised water with shaking for 5 min at 20° C., then dried in air for at least 3 h.

Spectrophotometric film thickness measurements showed that the green tea coating was 29.1 nm whilst the much thicker green tea-cinnamaldehyde coating was 156.2 nm. This is consistent with the green tea coating not being visible to the naked eye, whilst the thicker green tea-cinnamaldehyde coating is clearly visible, as shown in FIGS. 12a-c.

Reflection-absorption infrared spectroscopy (RAIRS) measurements showed the presence of an OH absorption band around 3500 cm⁻¹ for the green tea coating confirming the presence of polyphenols (this band is not present in cinnamaldehyde). In the green tea-cinnamaldehyde coating RAIRS spectrum, peaks at 2814 and 2742 cm⁻¹ correspond to cinnamaldehyde aldehyde C—H stretching (2814 and 2742 cm⁻¹), therefore indicating the presence of cinnamaldehyde in the tea coating. The cinnamaldehyde C═O (1668 cm⁻¹), and C═C (1625 cm⁻¹) absorptions cannot be distinguished from the tea polyphenol C═O and C═C absorptions.

### Cinnamaldehyde-Porous Substrates

Given that cinnamaldehyde loading in the coating has been shown to be a key factor governing antibacterial recycling capacity (FIG. 4 and FIG. 5), non-woven polypropylene host substrate was impregnated with cinnamaldehyde, Table 2. The cloth pieces were weighed before and after impregnation of cinnamaldehyde, and the average mass increase was measured to be 45±4 mg cm⁻², Table 2.

Testing against E. coli and S. aureus showed complete killing of the bacteria (Log₁₀ reduction=9.31±0.12 and 8.76±0.07 respectively). Seventeen consecutive antibacterial recycling tests against E. coli. (equivalent to cloths being in continuous contact with bacteria in liquid for 68 hours), showed that the cloths killed all bacteria on each occasion (Log₁₀ reduction=˜9), FIG. 9. Note in FIG. 9 that the values are reported as the average Log₁₀ reduction relative to untreated non-woven polypropylene cloth (average±standard deviation).

Since cinnamaldehyde was found to impregnate into non-woven polypropylene cloth without the need for any extra reagents (e.g. aforementioned polydopamine, polyethyleneimine, tannic acid or tris(hydroxymethyl)aminomethane), alternative porous material substrates were also evaluated in order to assess the broader applicability of this approach. Porous polytetrafluoroethylene (PTFE) membrane was chosen as a more hydrophobic type of material. Untreated PTFE membrane exhibited no antibacterial activity, whereas the cinnamaldehyde impregnated PTFE membrane gave rise to complete killing of E. coli (Log₁₀ reduction=9.27±0.04).

Considering that the aforementioned polypropylene and PTFE porous substrates are both hydrophobic and therefore unlikely to absorb water in preference to cinnamaldehyde whilst immersed in aqueous solution, cotton fabric was selected as a hydrophilic porous material for comparison. Untreated cotton displayed no antibacterial effect, whereas the cinnamaldehyde impregnated cotton pieces killed all E. coli (Log₁₀ reduction=9.29±0.06), thereby confirming that the hydrophilic cotton was capable of sufficient cinnamaldehyde uptake to provide a strong antibacterial efficacy.

### Tannic Acid-Cinnamaldehyde-Metal Coatings

Untreated PET is shown in FIG. 14a and is transparent in appearance. Various coating mixture combinations were investigated whilst keeping the amount of tannic acid (30 mg) and cinnamaldehyde (30 mg) in solution constant, see FIGS. 14b-h. The tannic acid-cinnamaldehyde mixture gave rise to the formation of a uniform yellow coating on PET substrate. Tannic acid-silver nitrate (10 mg) control coating showed a faint brownish tint, whilst tannic acid-cinnamaldehyde-silver nitrate (10 mg) was yellow in colour, with a grey mottled pattern. For higher silver salt content formulations, tannic acid-silver nitrate (30 mg) produced a non-uniform brown coating. Whilst the corresponding tannic acid-cinnamaldehyde-silver nitrate (30 mg) coatings were found to be uniform, opaque, and black in appearance. At the highest silver salt concentrations employed, the tannic acid-silver nitrate (50 mg) coating showed a uniform opaque red-orange colour, whereas the tannic acid-cinnamaldehyde-silver nitrate (50 mg) coating was an uneven pale red-dark grey colour, with numerous black spots deposited across the surface. Therefore, the optimum coating formulations selected were tannic acid-silver nitrate (50 mg) and tannic acid-cinnamaldehyde-silver nitrate (30 mg).

Thickness measurements showed that the tannic acid-only coating is extremely thin (less than one nanometre), indicating that tannic acid alone does not readily form a coating under the experimental conditions employed, Table 8. In contrast, the tannic acid-cinnamaldehyde and tannic acid-cinnamaldehyde-silver nitrate (30 mg) coatings are found to be several orders of magnitude thicker (greater than 100 nm).

TABLE 8
Thickness values for tannic acid-based, and tea-
based coatings deposited onto silicon wafer.

| Coating | Thickness/nm |
|---|---|
| Tannic acid-Only | 0.5 ± 0.3 |
| Tannic acid-Cinnamaldehyde | 183 ± 4 |
| Tannic acid-Silver nitrate (50 mg) | 65 ± 25 |
| Tannic acid-Cinnamaldehyde-Silver nitrate (30 mg) | 136 ± 13 |

### Tea-Cinnamaldehyde-Metal Coatings

### Tea-Cinnamaldehyde Coating

Green tea-only coating produced no visible change to the substrates, FIG. 15(b). In contrast, the green tea-cinnamaldehyde (30 mg) solution produced an opaque, yellow-brown coating that fully covered the substrate, FIG. 15(c). Higher concentrations of cinnamaldehyde were found not to be optimal—a patchy coating was obtained for tea-cinnamaldehyde (50 mg), while a tea-cinnamaldehyde (100 mg) solution produced a poorly adhered oily coating with incomplete coverage. Hence, the optimum tea-cinnamaldehyde (30 mg) solution was selected for further investigation.

Thickness values for the coatings on Si wafer are shown in Table 10. The tea-cinnamaldehyde coating is thicker than the tea-only coating.

TABLE 10
Thickness values for tea-based coatings deposited
onto silicon wafer. 30 mg cinnamaldehyde and/or
10 mg metal salt added to 10 ml tea solution.

| Coating | Thickness/nm |
|---|---|
| Tea-Only | 14 ± 12 |
| Tea-Cinnamaldehyde | 151 ± 5 |
| Tea-Copper sulphate pentahydrate | 1.3 ± 1.6 |
| Tea-Cinnamaldehyde-Copper sulphate pentahydrate | 146 ± 5 |
| Tea-Silver nitrate | 0.7 ± 0.9 |
| Tea-Cinnamaldehyde-Silver nitrate | 159 ± 16 |

The tea-cinnamaldehyde coatings were found to be at least an order of magnitude thicker than the tea-only coatings (approximately 151 nm versus 14 nm respectively, Table 10). The tea-cinnamaldehyde coating shows rapid formation, reaching maximum thickness in 5 min, with very little subsequent variation in thickness values, FIG. 21. In contrast, the tea-only coating is ultrathin, and does not get appreciably thicker after 24 h.

Infrared spectroscopy indicated that the tea-only coating displayed absorbance features similar to those previously reported for tea-staining studies and tea extracts, see FIG. 16: O—H stretch (3500-3300 cm⁻¹), C—H stretch (2915 cm⁻¹ and 2847 cm⁻¹), C═O stretch, C═C stretch and N—H bend (1700-1450 cm⁻¹), and C—O stretch (1300-1200 cm⁻¹), FIG. 22. The infrared spectrum of the tea-cinnamaldehyde coating displays similar absorbances to those seen for the tea-only coating. The incorporation of cinnamaldehyde into the tea-cinnamaldehyde coating is confirmed by the presence of cinnamaldehyde aldehyde C—H stretching features (2814 cm⁻¹ and 2742 cm⁻¹) and ring summation peaks (2000-1700 cm⁻¹)—all absent in the tea-only coating infrared spectrum. It was not possible to distinguish cinnamaldehyde C═O aldehyde (1668 cm⁻¹) and C═C (1625 cm⁻¹) absorbances from overlapping tea C═O, C═C, and N—H bond absorbances (1700-1450 cm⁻¹).

PET was also coated with green tea-eugenol (30 mg) which resulted in a very light green-yellow coating, see FIG. 17.

### Tea-Cinnamaldehyde-Copper Coatings

Tea-copper and tea-cinnamaldehyde-copper coatings were deposited onto PET substrates, FIG. 15. The tea-copper (10 mg) coating showed no visible change, FIG. 15f. The tea-cinnamaldehyde-copper sulphate pentahydrate (10 mg) coating showed an opaque orange-brown coating. Tea-copper sulphate pentahydrate (50 mg) and tea-cinnamaldehyde-copper sulphate pentahydrate (50 mg) coatings were similar in appearance to their 10 mg equivalents.

The tea-cinnamaldehyde-copper sulphate pentahydrate (10 mg) coating was measured to be of comparable thickness to the tea-cinnamaldehyde coating indicating that copper incorporation does not significantly impact film thickness, Table 10. The coating shows slower growth than tea-cinnamaldehyde coating, only approaching the maximum thickness after 24 h, FIG. 21.

XPS analysis of the tea-cinnamaldehyde-copper sulphate pentahydrate (10 mg) coating confirmed that copper was present in the coating and there was an absence of sulphur, Table 11. X-ray diffraction (XRD) analysis of uncoated and tea-cinnamaldehyde coated glass slides indicated amorphous structure with no crystalline peaks, FIG. 22. X-ray diffraction and transmission electron microscopy (TEM) analysis of the tea-cinnamaldehyde-copper sulphate pentahydrate (10 mg) coating did not provide any evidence for the formation of large copper crystallites and is consistent with a high level of metallic species dispersion, FIG. 22 and FIG. 23. Features attributable to the organic component of the coating (i.e. tea-cinnamaldehyde) were visible in the TEM images.

TABLE 11
XPS atomic percentages of tea-cinnamaldehyde and tea-cinnamaldehyde-
metal coatings on PET substrate. 30 mg cinnamaldehyde and 10 mg metal
salt added to 10 ml tea solution. No sulphur was detected.

| | XPS Atomic Composition/% | | | | |
|---|---|---|---|---|---|
| Coating | C | N | O | Cu | Ag |
| Tea-Cinnamaldehyde | 80.7 ± 0.6 | 0.5 ± 0.1 | 18.8 ± 0.7 | — | — |
| Tea-Cinnamaldehyde- | 76.6 ± 0.7 | 0.8 ± 0.1 | 22.4 ± 0.7 | 0.20 ± 0.04 | — |
| Copper | | | | | |
| Tea-Cinnamaldehyde- | 79.5 ± 1.6 | 0.6 ± 0.3 | 19.8 ± 1.5 | — | 0.10 ± 0.04 |
| Silver | | | | | |

Potential metal leaching of the tea-cinnamaldehyde-copper coating deposited onto hydrophilic polypropylene cloth upon immersion into water was examined using ICP-OES over a range of immersion times (30 s-24 h). A control ‘blank’ was also run, where an uncoated piece of hydrophilic non-woven polypropylene cloth substrate was immersed into water for 24 h, in order to check that there were not any significant amounts of copper in the water, glass vial, cloth, or nitric acid. No increase or trend was observed in the quantities of copper detected in solution after 24 h immersion, and the copper concentrations remained very low (<4 ppm, i.e. <4 μg ml⁻¹). Visually the coated cloths looked completely unchanged after 24 h immersion. Therefore, the tea-cinnamaldehyde-copper coating is stable, and the copper component is not prone to rapid leaching out into aqueous media.

### Tea-Cinnamaldehyde-Silver Coatings

Tea-silver and tea-cinnamaldehyde-silver coatings were synthesised, FIG. 15. The tea-silver (10 mg) coating shows a slight grey colouration, FIG. 15d, whereas the tea-cinnamaldehyde-silver (10 mg) coating, FIG. 15e, shows an opaque dark greyish-brown coating. The corresponding higher loading tea-silver nitrate (50 mg) and tea-cinnamaldehyde-silver nitrate (50 mg) coatings were found to be a darker grey colouration and non-uniform dark grey with a brown tint respectively. As noted for the copper-containing coatings, the thickness of the tea-cinnamaldehyde-silver nitrate (10 mg) coating was comparable to the tea-cinnamaldehyde coating, thereby indicating that the incorporation of silver does not have a significant effect upon coating thickness, Table 10. Tea-cinnamaldehyde-silver coating thickness increased at a slower rate compared to the tea-cinnamaldehyde coating, approaching the maximum coating thickness after 20-30 min, FIG. 21.

XPS characterisation of the tea-cinnamaldehyde-silver nitrate (10 mg) coating surface confirmed the incorporation of silver into the coating, Table 11. The carbon, oxygen, and nitrogen elemental composition was similar to the control tea-cinnamaldehyde coating, indicating that silver incorporation does not significantly affect formation of the coating (which is consistent with the aforementioned thickness measurements, Table 10).

X-ray diffraction analysis of the tea-cinnamaldehyde-silver nitrate (10 mg) coating gave rise to the appearance of new peaks which confirm the reduction of silver nitrate to metallic silver crystallites taking place (20=38.0°, 44.3°, 64.5°, and 77.5° corresponding to silver (111), (200), (220), and (311) crystal planes respectively).

Transmission electron microscopy analysis of the tea-cinnamaldehyde-silver nitrate (10 mg) coating showed nanostructured metal aggregates at lower magnifications, and individual silver nanoparticles at higher magnifications, FIG. 23.

Leaching tests for silver from the tea-cinnamaldehyde-silver nitrate coating on hydrophilic non-woven polypropylene cloth yielded similar results to the tea-cinnamaldehyde-copper sulphate pentahydrate coating—no increase or trend was observed, and the silver content remained low (less than 2 ppm) after 24 h, thus indicating that the silver does not readily leach into aqueous medium from the coating. It was attempted to determine the metal contents of both the tea-cinnamaldehyde-copper and tea-cinnamaldehyde-silver coatings via ICP-OES by depositing them first onto glass, then scraping off the coatings, and digesting them in nitric acid. However, it was found that the coatings were completely resistant to digestion; even after reflux at 200° C. for 24 h in 5% v/v nitric acid, the solid coatings were visibly not digested/dissolved. Therefore, the coatings appear to be robust.

Tea-cinnamaldehyde-metal coatings could be deposited onto a wide range of substrate materials, for example, glass, PTFE, cotton gloves, hydrophilic non-woven polypropylene cloth, and tennis balls.

### Antibacterial Testing

Tea-cinnamaldehyde coating on hydrophilic non-woven polypropylene cloth showed complete killing of E. coli and S. aureus, giving Log₁₀ Reduction values of 8.44±0.07 and 7.90±0.09 respectively, Table 12. The tea-cinnamaldehyde-copper and tea-cinnamaldehyde-silver coatings also gave complete killing of both bacteria (thus yielding identical Log₁₀ Reduction values towards respective bacteria, since all three coatings were tested concurrently alongside the same controls), Table 12.

TABLE 12
Antibacterial tests for tea-cinnamaldehyde, tea-cinnamaldehyde-
copper, and tea-cinnamaldehyde-silver coatings on hydrophilic
non-woven polypropylene cloth. 900 mg cinnamaldehyde and
300 mg metal salt added to 400 ml tea solution. Values
are given as mean ± standard deviation.

Bacterial Log₁₀ Reduction

| Coating | E. coli | S. aureus |
|---|---|---|
| Tea-Cinnamaldehyde | 8.44 ± 0.07 | 7.90 ± 0.09 |
| Tea-Cinnamaldehyde-Copper | 8.44 ± 0.07 | 7.90 ± 0.09 |
| Tea-Cinnamaldehyde-Silver | 8.44 ± 0.07 | 7.90 ± 0.09 |

### Antiviral Testing

Non-woven polypropylene face masks were coated with tea-cinnamaldehyde-copper and tea-cinnamaldehyde-silver, FIG. 20a. The front sheet of the mask was removed and tested against murine coronavirus (MHV-A59), Table 13. Tea-cinnamaldehyde-copper coating produced a 98.6% reduction in the viral titre after 2 h contact time, while the tea-cinnamaldehyde-silver coating gave a 99.8% reduction. In contrast, there was no decrease in MHV-A59 titre recovered from the control untreated mask material corresponding to the same contact time.

TABLE 13
Median Tissue Culture Infectious Dose (TCID50) values
(expressed as Log₁₀ values); and percentage (%) reduction
of viral titre values after 2 h contact time for murine
coronavirus (MHV-A59) on face mask fabric. Error associated
with the test technique employed is approximately 0.5 Log₁₀,
hence these data are indicative of virucidal activity
associated with the coatings. 900 mg cinnamaldehyde and
300 mg metal salt added to 400 ml tea solution.

| | TCID50 (Log₁₀ values) | | % |
|---|---|---|---|
| Sample | 0 h | 2 h | Reduction |
| Control | −7.28 | −7.37 | 0 |
| Tea-Cinnamaldehyde-Copper | −7.63 | −5.78 | 98.6 |
| Tea-Cinnamaldehyde-Silver | −7.56 | −4.93 | 99.8 |

### Coated Cotton Fabric

The tea-cinnamaldehyde-copper coatings can be applied to a wide range of substrates, including for example cotton fabric, face masks, gloves and the like, see FIGS. 19 and 20.

### Norepinephrine-Cinnamaldehyde Coating

Untreated PET was colourless and transparent, FIG. 24a. Polynorepinephrine coated PET showed a faint, transparent brown coating, FIG. 24b. Polynorepinephrine-cinnamaldehyde (30 mg) coating gave a solid red coating, FIG. 24c, as did polynorepinephrine-cinnamaldehyde (60 mg) coating, FIG. 24d. Polynorepinephrine-cinnamaldehyde (100 mg) coating and polynorepinephrine-cinnamaldehyde (150 mg) coating both gave sticky, oily (i.e. liquid), non-uniform, red coloured coatings, FIGS. 24e & f.

Infrared spectrum of norepinephrine hydrochloride showed the following characteristic absorption bands: N—H and O—H stretches (3266 cm⁻¹, br), C—H stretch (3056 cm⁻¹ and 2960 cm⁻¹), C═C stretch (1630 cm⁻¹), NH₂ scissoring (1602 cm⁻¹), and OH in-plane bend (1240 cm⁻¹), FIG. 25a. Polynorepinephrine coating showed O—H stretch (3300 cm⁻¹, br), and aromatic C═C stretches (1619 cm⁻¹ and 1510 cm⁻¹), FIG. 25b. Polynorepinephrine-cinnamaldehyde (60 mg) coating showed cinnamaldehyde aldehyde C—H stretching peaks at 2814 cm⁻¹ and 2742 cm⁻¹, and cinnamaldehyde C═O stretch peak at 1668 cm⁻¹, which are not present in norepinephrine IR spectra, therefore confirming the presence of cinnamaldehyde in the coating, FIG. 25c & d. Interestingly, the broad O—H stretching peak (3300 cm 1) is not present in the polynorepinephrine-cinnamaldehyde (60 mg) coating IR spectrum, and two new peaks are visible at 3538 cm⁻¹ and 3436 cm⁻¹—these peaks are not present in the IR spectra of norepinephrine hydrochloride, polynorepinephrine coating, or cinnamaldehyde. This indicates that the cinnamaldehyde has an effect on the OH groups of the polynorepinephrine coating.

### SUMMARY

Polydopamine, tannic acid, and cinnamaldehyde are biodegradable and are not harmful to human health. The polydopamine-cinnamaldehyde, polyethyleneimine-cinnamaldehyde, and tannic acid-cinnamaldehyde coatings exhibit strong antibacterial activity against both Gram-negative and Gram-positive bacteria. They retained their red, off-white, and yellow colours respectively following antibacterial test recycling. This indicates that the coatings are well adhered to the underlying substrates, and the solid host polymer coating alone cannot be responsible for the observed antibacterial activity. Cinnamaldehyde interacts with the polydopamine, polyethyleneimine, or tannic acid during coating formation, either reacting, binding via non-covalent interactions, or becoming trapped within the polymer coating. Cinnamaldehyde within the host polymers results in better compatibilization for excess cinnamaldehyde oil—the surface energies of the solid and fluid become better matched, leading to highly stable entrapped cinnamaldehyde liquid. Cinnamaldehyde is then able to leach out (release) during the antibacterial testing studies (FIG. 4 and FIG. 5). Once the cinnamaldehyde has become depleted, there is no longer any antibacterial activity. The solution for polyethyleneimine-cinnamaldehyde coated PET film after 48 hours immersion in water displayed a lower final UV-Vis absorbance compared to polydopamine-cinnamaldehyde or tannic acid-cinnamaldehyde coated PET films, FIG. 5. This correlates with its lower overall antibacterial efficacy against E. coli, as well as quicker loss of activity during antibacterial recycling, and with its smaller mass increase (thickness), Table 2, Table 3, and FIG. 4.

Unlike dopamine/polydopamine and polyethyleneimine, tannic acid does not contain amine functional groups, meaning that it cannot undergo the Schiff base reaction observed for dopamine/polydopamine and polyethyleneimine. Rather tris(hydroxymethyl)aminomethane) plays a dual role both initiating oxidative polymerisation of tannic acid and reacting with cinnamaldehyde via Schiff base mechanism which in turn may help to entrap cinnamaldehyde. The trapped tris(hydroxymethyl)aminomethane-cinnamaldehyde Schiff base product may also be antibacterial. Another possibility is that tannic acid and cinnamaldehyde interact with each other via non-covalent bonding such as π-π interactions, hydrogen bonding or hydrophobic interactions to form an insoluble coating, with excess less strongly bound cinnamaldehyde able to release into water. Alternative conceivable mechanisms could include an oxa-Michael type reaction (whereby tannic acid OH groups are deprotonated by base to form an oxyanion which then performs a nucleophilic attack on the cinnamaldehyde alkene group leading to bond formation between the tannic acid and cinnamaldehyde).

Antibacterial activities have been reported previously for cinnamaldehyde impregnated into porous substrates including microporous polyurethane, polypropylene foot sweat pads, and wet wipes made from cellulose and polyester. However, no recycle/reuse testing was performed.

The present invention opens up scope for the large scale, low cost fabrication of antibacterial coatings using plant-derived essential oil compounds (as alternatives to environmentally harmful metal-based systems). Naturally occurring and synthetic antimicrobial compounds could also be incorporated (including those with antiviral, antifouling, antifungal, or antiparasitic properties). These coating methods could also be extended to other plant-based polyphenol compound coatings besides polydopamine and tannic acid as well as the utilisation of polyphenol-containing solutions such as polyphenol content of fruit juice, red wine, cacao, chocolate, tea leaves, herbal tea, and spiced beverages. Potential applications include healthcare, as well as preventing the spread of pathogens and diseases, building materials, transportation, clothing, footwear, active food packaging, antiviral, antifouling, antifungal, antiparasitic, preventing biofilm formation, aerospace, food processing, de-icing, icephobic, corrosion resistance, droplet motion control, mineral fouling mitigation, marine coatings, water purification, refrigeration, personal protection equipment, motor vehicles, windscreens, spectacles, printers, printing, lithography, wound dressings, microelectromechanical devices, plumbing, sensors, oil wells, heat exchangers, building ventilation, food storage, medical implants, batteries, solar energy devices, electrical barrier coatings, anti-fingerprint coatings, anti-adhesive, contact lenses, antimicrobial coatings, fog harvesting, water harvesting, underwater bubble transportation, condensation, drag reduction, and dew collection.

The entrapped cinnamaldehyde coatings can be applied to a variety of substrates without the need for organic solvents or any further derivatization of the surface. Polydopamine-cinnamaldehyde coatings show high antibacterial efficacy against towards both Gram-positive (S. aureus) and Gram-negative (E. coli) bacteria. Polyethyleneimine-cinnamaldehyde and tannic acid-cinnamaldehyde coatings also display good antibacterial activity against both E. coli and S. aureus. Cinnamaldehyde impregnated into a variety of porous substrates (non-woven polypropylene cloth, PTFE membrane, and knitted cotton), yields strong antibacterial performance, with non-woven polypropylene cloth impregnated with cinnamaldehyde exhibiting long-lasting, recyclable antibacterial activity.

The containment and optional subsequent release of or optional replenishment of surface-contained compounds can be controlled by the selection of containment compound, surface functionalisation, and external parameters such as temperature, solvent, pH, friction, sonication, immersion medium, and pressure.

### Tea-Cinnamaldehyde-Metal Coatings

In contrast to previous multiple-step fabrication approaches for antimicrobial coatings, the outlined single-step methodology is simple and cheap. Tea-only coatings form as a result of oxidation and polymerisation of the natural plant constituent polyphenols. In the absence of any other reagents, these types of polyphenol coatings typically require long reaction times (˜24 h) to produce a coating and tend to be ultrathin (14 nm), Table 10 and FIG. 21. In contrast, the tea-cinnamaldehyde coating reported in the present study shows rapid deposition, producing a 150 nm coating in as little as 5 min without any requirement for additional chemicals, Table 10 and FIG. 21. It is therefore unlikely that the tea-cinnamaldehyde coating forms solely as a result of oxidation reactions. One possible explanation for the rapid aggregation and precipitation of a coating which can spontaneously adhere to substrate surfaces in solution is that the tea-cinnamaldehyde coating forms due to various intermolecular interactions between the constituent tea compounds and cinnamaldehyde-such as hydrophobic interactions, π-π interactions, hydrogen bonding, and van der Waals' forces. Addition of silver nitrate or copper sulphate pentahydrate salts to the tea-cinnamaldehyde coating solution results in a slowing down of the deposition rate, but does not attenuate the final thickness, Table 10 and FIG. 21. This may be due to the metal ions interacting or coordinating with the tea compounds and/or cinnamaldehyde, thereby slowing the interactions between the tea compounds and cinnamaldehyde responsible for coating formation.

Previous reports on tannic acid-copper products describe the copper as being coordinated to the tannic acid in the form of Cu(II) coordinated with phenol oxygens. This may be applicable here with the copper centres coordinated to the structurally-similar tea polyphenol compounds within the coating (e.g. epigallocatechin gallate). The silver nanoparticles detected in the tea-cinnamaldehyde-silver coating are consistent with previous reports which have employed tea extract to reduce silver salts to generate nanoparticles, FIG. 23.

A rough estimate of the metal loading weight percent (wt %) can be made using the XPS atomic percentages: Cu=0.99 wt % for the tea-cinnamaldehyde-copper coating and Ag=0.84 wt % for the tea-cinnamaldehyde-silver coating, Table 11. It is possible that the metal content in the bulk may differ to that of the surface detected by XPS (sampling depth 2-5 nm); and that some of the metal at the surface may be encapsulated by the tea and cinnamaldehyde coating components—these values therefore represent a lower bound estimate. This strategy of using tea and essential oils in conjunction with metals enables much lower quantities of bioactive metals to be used, thereby alleviating any potential environmental and toxicological health concerns. The rates of metal leaching have been found to be very low (less than 5 ppm over 24 h).

The tea-cinnamaldehyde and tea-cinnamaldehyde-metal coatings readily adhere to a wide array of substrate material surfaces, including silicon, glass, polyester, polypropylene cloth, polytetrafluorethylene, and cotton. Adhesion is likely to occur via a similar mechanism to that reported for polydopamine coatings—the catechol and gallic acid moieties in the tea compounds provide strong types of interaction with the surface, allowing the coatings to stick.

Complete killing of both E. coli and S. aureus bacteria (Log₁₀ Reduction=8.44±0.07 and 7.90±0.09 respectively) is found for the tea-cinnamaldehyde coating. This is comparable to previously reported polydopamine-cinnamaldehyde and tannic acid-cinnamaldehyde coatings; and is many orders of magnitude better than the minimum Log₁₀ Reduction=3 recommended by the United States Environmental Protection Agency. Tea-cinnamaldehyde coatings containing silver or copper also showed complete killing of bacteria, indicating that addition of the metals does not negatively affect the antibacterial efficacy of the coatings, Table 12. The antibacterial activity of copper could be occurring via several modes of action: copper causes cell membrane damage, production of reactive oxygen species (ROS), and DNA fragmentation and disintegration. Similarly, silver is reported to be antibacterial via multiple mechanisms: silver has a high affinity to interact with sulphur groups (e.g. thiols) and phosphorus groups which can lead to inhibition of enzymes and also interactions with DNA may disrupt DNA replication—both leading to bacterial cell death. In addition, silver nanoparticles can cause damage to the cell membrane, resulting in leakage of the cell contents. They can also give rise to depletion of intracellular adenosine triphosphate (ATP) levels, and cause an increase in reactive oxygen species (ROS) within cells.

The infectivity of murine coronavirus MHV-A59 after a 2 h contact time with tea-cinnamaldehyde-copper and tea-cinnamaldehyde-silver coated face mask fabrics was attenuated by 98.6% and 99.8% respectively, Table 13. Copper is understood to inactivate viruses via production of hydroxyl free radicals which damage the virus, or via binding to cysteine residues on virus proteases. Inhibition of viruses with silver can occur via a number of different potential pathways depending on the virus type, including interfering with viral attachment mechanisms, breakage of sulphur-sulphur disulphide bonds in enzymes, or interacting with viral DNA. These metal-containing coatings display antiviral activities against murine coronavirus MHV-A59 which are comparable to those reported in the literature for copper and silver towards SARS-CoV-2—although accurate and direct comparisons are very difficult to make due to differing test procedures, type of virus, and metal loadings, etc. Regardless, the sheer simplicity and scalability make the present coatings highly suitable for widespread societal applications.

Alternative variations of these tea-cinnamaldehyde-metal coatings could combine together different elements (for example alloy formation), and the use of other natural compounds or essential oils to produce coatings with even more potent antimicrobial efficacies. Sustainability is also an important factor when considering societal applications of antimicrobial coatings. The utilisation of low amounts of bioactive metals whilst retaining high biocidal activities is beneficial to the environment.

The present invention has therefore also provided natural plant-derived antimicrobial coatings synthesised by mixing breed tea with cinnamaldehyde oil. Concurrent addition of copper or silver salts produces tea-cinnamaldehyde-copper and tea-cinnamaldehyde-silver coatings respectively. Tea-cinnamaldehyde, tea-cinnamaldehyde-copper, and tea-cinnamaldehyde-silver coatings are all found to display strong antibacterial efficacy against both Gram-negative E. coli and Gram-positive S. aureus (Log₁₀ Reduction=8.44 and 7.90 respectively). Tea-cinnamaldehyde-copper and tea-cinnamaldehyde-silver hybrid coatings deposited onto personal protection face masks provide 98.6% and 99.8% deactivation respectively towards murine coronavirus MHV-A59 (a potential surrogate for COVID-19 global pandemic coronavirus SARS-CoV-2). Key advantages are that the coating fabrication involves a single-step, uses cheap reagents which are widely available over the counter to the general public, does not require any equipment apart from a container, and the coatings spontaneously adhere to a variety of substrate materials (including silicon, glass, polyester, non-woven polypropylene, polytetrafluoroethylene, and cotton). Tea is one of the most ubiquitous beverages in the world, meaning that these antimicrobial coatings could be produced locally almost anywhere and by anyone without the need for any specialised technical training or expertise (for example, at remote field hospitals during humanitarian crises and in low-income countries).

Tea-cinnamaldehyde and tea-cinnamaldehyde-metal coatings spontaneously adhere to substrates (including silicon, glass, polyester, polypropylene, polytetrafluoroethylene, and cotton) and give rise to complete killing of both E. coli and S. aureus bacteria after 4 h exposure (Log₁₀ Reduction=8.44±0.07 and 7.90±0.09 respectively). Tea-cinnamaldehyde-copper and tea-cinnamaldehyde-silver coatings gave 98.6% and 99.8% reduction respectively against murine coronavirus, MHV-A59 after 2 h exposure. These single-step fabrication coatings utilise cheap and readily available everyday reagents which do not require any specialized technical expertise or equipment.

1. A coating, said coating comprising:
cinnamaldehyde, a cinnamaldehyde derivative, an essential oil, or an essential oil-derived compound; and
a polyphenol, polyethyleneimine or poly(4-vinylaniline).

2. A coating according to claim 1, wherein said coating is an antibacterial coating, an antimicrobial coating, a non-stick coating, anti-adhesive coating, and/or a lubricant.

3. A coating according to claim 1, wherein said polyphenol comprises polydopamine; tannic acid; or a polyphenol-containing solution, selected from the group comprising fruit juice, wine, cacao, chocolate and/or tea.

4. A coating according to claim 3, wherein where said coating includes polydopamine, said polydopamine is formed from polymerization of dopamine hydrochloride in a solution of an appropriate agent to induce said polymerization.

5. A coating according to claim 4, wherein said agent is an aqueous solution of tris(hydroxymethyl)aminomethane (Tris).

6. (canceled)

7. A coating according to claim 1, wherein where said coating is provided as a combination of cinnamaldehyde and polyethyleneimine, the mass ratio of the two compounds is approximately 1:1.

8.-13. (canceled)

14. A method of preparing a coating, said method including the steps of:
providing an amount of cinnamaldehyde, a cinnamaldehyde derivative, an essential oil, or an essential oil-derived compound;
mixing said cinnamaldehyde, cinnamaldehyde derivative, essential oil, or essential oil-derived compound with an amount of a polyphenol, polyethyleneimine or poly(4-vinylaniline);
placing a substrate into the combined mixture for a predetermined period of time;
removing the substrate from the mixture;
washing, and subsequently drying the substrate to provide the same with the coating thereon.

15. A method of preparing a coating, said method including the steps of:
providing a solution of cinnamaldehyde, a cinnamaldehyde derivative, an essential oil, or an essential oil-derived compound;
providing a substrate on to which the coating is to be applied;
functionalising the surface of the substrate via the deposition of a polymer thereon;
immersing the polymer-coated substrate into the solution of cinnamaldehyde, cinnamaldehyde derivative, essential oil, or essential oil-derived compound for a predetermined period of time;
removing the substrate from the solution;
washing, and subsequently drying the substrate to provide the same with the coating thereon.

16. A method according to claim 15, wherein the substrate surface is functionalised by one of a range of different techniques, including: thermal chemical vapour deposition; plasma polymerization; chemical vapour deposition (CVD); initiated chemical vapour deposition (iCVD); plasma enhanced chemical vapour deposition (PECVD); liquid spray deposition; excited liquid spray deposition; photodeposition; ion-assisted deposition; electron beam polymerization; gamma-ray polymerization; target sputtering; atomic layer deposition (ALD); graft polymerization; surface coupling reactions; or solution phase polymerization.

17-18. (canceled)

19. A coating, said coating comprising:
cinnamaldehyde, a cinnamaldehyde derivative, an essential oil, or an essential oil-derived compound;
a metal, metal-salt or metal-compound; and
a polyphenol or a polyphenol-containing substance or solution.

20. A coating according to claim 19, wherein said coating is an antibacterial coating, an antimicrobial coating, a non-stick coating, anti-adhesive coating, and/or a lubricant.

21. A coating according to claim 19, wherein said metal, metal-salt or metal-compound includes silver or copper, or silver- or copper-salts or compounds thereof.

22. A coating according to claim 19, wherein said metal salts comprise silver nitrate or copper sulphate pentahydrate.

23. A coating according to claim 19, wherein said polyphenol is provided as an amount of tannic acid; or the polyphenol-containing substance or solution includes any of the following: fruit juice, wine, cacao, chocolate, coffee, herbal tea, and spiced beverages.

24. (canceled)

25. A coating according to claim 19, wherein said coating components are provided in an appropriate buffer solution, chosen form the group comprising tris(hydroxymethyl)aminomethane (Tris); Bis(2-hydroxyethyl)amino-tris(hydroxymethyl)methane) (Bis-Tris); N,N-Bis(2-hydroxyethyl)glycine) (Bicine); ethylamine; tetramethylethylenediamine; piperidine; pyridine; diethylamine; octadecylamine; triethanolamine; sodium hydroxide; sodium bicarbonate; phosphate buffered saline; sodium chloride solution; copper salts, e.g., copper sulphate; hydrogen peroxide and/or combinations thereof.

26.-31. (canceled)
